(19) United States
(12) Patent Application Publication
(10) Pub. No.: US 2015/0339538 A1
(43) Pub. Date: Nov. 26, 2015

(54) ELECTRONIC CONTROLLER, CONTROL METHOD, AND CONTROL PROGRAM

(71) Applicant: NIKON CORPORATION, Tokyo (JP)

(72) Inventor: Atsushi TANAKA, Tokyo (JP)

(21) Appl. No.: 14/820,158

(22) Filed: Aug. 6, 2015

Related U.S. Application Data
(63) Continuation of application No. PCT/JP2014/052916, filed on Feb. 7, 2014.

(30) Foreign Application Priority Data
Feb. 8, 2013 (JP) 2013-023270
Feb. 8, 2013 (JP) 2013-023271

(51) Int. Cl. G06K 9/32; G08B 13/196; G06K 9/00; H04N 7/18; H04N 5/33

(52) U.S. Cl. CPC G06K 9/3241; H04N 7/183; H04N 7/188; H04N 5/33; G06K 9/00248; G06K 9/00993; G08B 13/196; G06K 2209/21; G06K 2209/27

(57) ABSTRACT

An electronic controller includes an image-capturing unit, an irradiation unit emitting light, a recognition unit recognizing a type of an object existing in an input region indicated by the light emitted from the irradiation unit which is an object captured by the image-capturing unit, and an acquisition unit acquiring information according to the type of the object which is information included in the object of which the type is recognized by the recognition unit.

### CROSS-REFERENCE TO RELATED APPLICATION

This is a Continuation application of International Application No. PCT/JP2014/052916, filed on Feb. 7, 2014, which claims priority to Japanese Patent Application No. 2013-023270 and Japanese Patent Application No. 2013-023271, filed on Feb. 8, 2013, the contents of which are incorporated herein by reference.

### BACKGROUND

1. Field of the Invention

The present invention relates to an electronic controller, a control method, and a control program.

2. Description of the Related Art

Recently, various electronic controllers are known.

A bar code scanner reading a bar code is known (for example, refer to Japanese Unexamined Patent Application, First Publication No. 2012-226750).

In addition, for example, in Japanese Unexamined Patent Application, First Publication No. 2012-160079, it is disclosed that an operation in which a user holds their fingertip at a certain position on a screen over a threshold time period is set as an activation operation of displaying an interface such as a menu or an icon, or an operation drawing a circular locus with respect to the screen is set as an activation operation.

### SUMMARY

The bar code scanner of the related art described above is only able to read a bar code. For this reason, it is not possible to acquire information included in a plurality of types of objects, and thus convenience is not sufficient.

In addition, in a technology disclosed in Japanese Unexamined Patent Application, First Publication No. 2012-160079, only the menu or the icon which is an item selected by the user is displayed, and thus information which is able to be input is limited. Further, the menu or the icon to be displayed has a definite shape, and a suitable range of a size or a position of a space to be displayed is not able to be set. Thus, in the technology disclosed in Japanese Unexamined Patent Application, First Publication No. 2012-160079, a desired interface of the user may not be provided.

One object of an aspect of the present invention is to provide an electronic controller or the like which is highly convenient.

In addition, another object is to provide an electronic controller in which a desired information input of a user is able to be provided, a control method, and a control program.

According to an aspect of the present invention, there is provided an electronic controller, including: an image-capturing unit; an irradiation unit configured to emit light; a recognition unit configured to recognize a type of an object existing in an input region indicated by the light emitted from the irradiation unit, the object being an object captured by the image-capturing unit; and an acquisition unit configured to acquire information which is included in the object of which the type is recognized by the recognition unit and is according to the type of the object.

According to another aspect of the present invention, there is provided an electronic controller, including: an image-capturing unit; a control unit configured to determine an information input range into which information is input according to a shape of an object captured by the image-capturing unit; and an irradiation unit configured to emit light indicating the information input range, in which the information is able to be input in the information input range in a state in which the light is emitted.

According to still another aspect of the present invention, there is provided a control method of an electronic controller which includes an image-capturing unit and an irradiation unit emitting light, the method including: using a control computer of the electronic controller for: capturing an image of an object by an image-capturing unit; determining an information input range into which information is input according to a shape of the image-captured object by a control unit; and emitting light indicating the determined information input range by an irradiation unit, in which the information is able to be input in the information input range in a state in which the light is emitted.

According to still another aspect of the present invention, there is provided a control program causing a control computer an electronic controller, which includes an image-capturing unit and an irradiation unit emitting light, to: capture an object; determine an information input range into which information is input according to a shape of the image-captured object; and emit light indicating the determined information input range, in which the information is able to be input in the information input range in a state in which the light is emitted.

According to the aspects of the present invention, it is possible to provide an electronic controller or the like which is highly convenient. In addition, according to the aspect of the present invention, a desired information input of a user is able to be provided.

### BRIEF DESCRIPTION OF DRAWINGS

FIG. 1 is a diagram illustrating an example of a functional configuration and a communication environment of an electronic controller according to one embodiment of the present invention.

FIG. 2 is a diagram schematically illustrating a state in which the electronic controller is installed in a building.

FIG. 3 is a diagram illustrating an example of a functional configuration of a control unit.

FIG. 4 is a diagram illustrating a state in which an input region setting unit sets an input region.

FIG. 5 is a diagram illustrating an example of information stored in a data for recognizing storage unit.

FIG. 6 is an example of a flowchart illustrating a flow of processing executed by the control unit of this embodiment.

FIG. 7 is a configuration diagram illustrating an example of a configuration of an image-capturing irradiation device in which an irradiation unit and an image-capturing unit are integrally configured.

FIG. 8 is a schematic view illustrating a usage example of an electronic controller according to another embodiment of the present invention.

FIG. 9 is a schematic block diagram illustrating a configuration of the electronic controller according to this embodiment.

FIG. 10 is a schematic view illustrating an example of input range determination processing according to this embodiment.

FIG. 11 is a schematic block diagram illustrating a configuration of a control unit according to this embodiment.

FIG. 12 is a flowchart illustrating an example of an operation of the electronic controller according to this embodiment.

FIG. 13 is a schematic view illustrating an example of input range determination processing according to a first modification example of this embodiment.

FIG. 14 is a schematic view illustrating an example of input range removal processing according to a second modification example of this embodiment.

FIG. 15 is a schematic view illustrating an example of input range determination processing according to a third modification example of this embodiment.

FIG. 16 is a schematic view illustrating an example of input range determination processing according to a fourth modification example of this embodiment.

FIG. 17 is a schematic view illustrating an example of processing of an electronic controller according to a fifth modification example of this embodiment.

FIG. 18 is a schematic view illustrating another usage example of an electronic controller according to a sixth modification example of this embodiment.

FIG. 19 is a schematic view illustrating an example of input range determination processing according to the sixth modification example of this embodiment.

FIG. 20 is a schematic view illustrating an example of input range determination processing according to a seventh modification example of this embodiment.

FIG. 21 is a schematic view illustrating an example of a display according to an eighth modification example of this embodiment.

FIG. 22 is a schematic view illustrating an example of an input range table according to a ninth modification example of this embodiment.

### DESCRIPTION OF EMBODIMENTS

Hereinafter, embodiments of an electronic controller, a control method of an electronic controller, and a control program of an electronic controller of the present invention will be described with reference to the drawings. In the following description, the electronic controller has an aspect in which at least an irradiation unit and an image-capturing unit which are part of the configuration thereof are attached to a wall surface or a ceiling of a building. However, the present invention is not limited thereto, and part or all of the electronic controller may be carried by a user. For example, the electronic controller of the present invention may be a camera having a communication function, a camera-inclusive mobile phone, a camera-inclusive personal computer (including a desktop computer, a laptop computer, and a portable electronic device), and the like.

[Configuration]

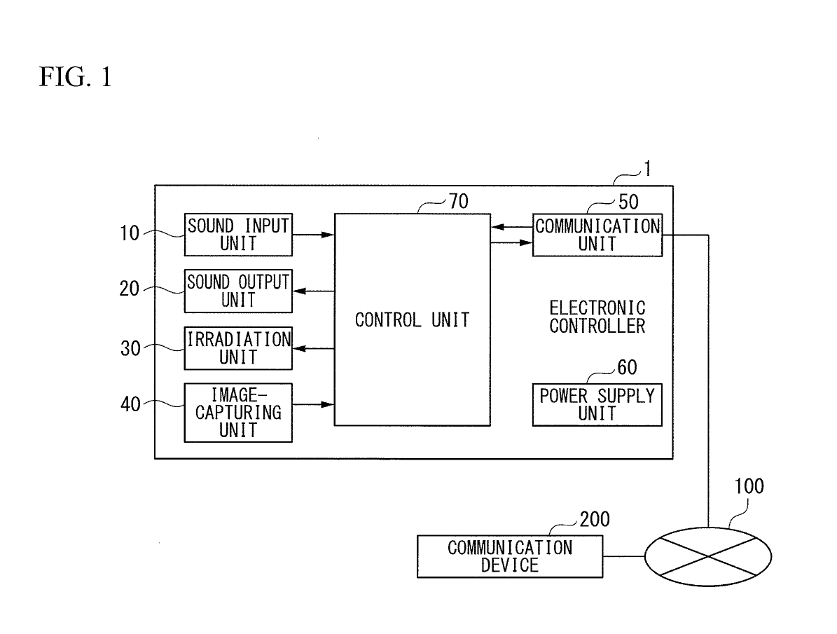

FIG. 1 is a diagram illustrating an example of a functional configuration and a communication environment of an electronic controller 1 according to one embodiment of the present invention. The electronic controller 1, for example, includes a sound input unit 10, a sound output unit 20, an irradiation unit 30, an image-capturing unit 40, a communication unit 50, a power supply unit 60, and a control unit 70.

The sound input unit 10, for example, is a microphone, and outputs data of an input sound to the control unit 70. The sound output unit 20, for example, includes a speaker and/or a buzzer, and outputs a sound. The sound output unit 20 outputs a sound, a music, an alarm, and the like which are generated by the control unit 70.

The irradiation unit 30, for example, is configured to function as a projection device (a projector) which projects an image generated by the control unit 70. The image-capturing unit 40, for example, is a camera using a solid image-capturing device such as a Charge Coupled Device (CCD) or a Complementary Metal Oxide Semiconductor (CMOS). The image-capturing unit 40 is not limited thereto. As the image-capturing unit 40, various devices are able to be adopted.

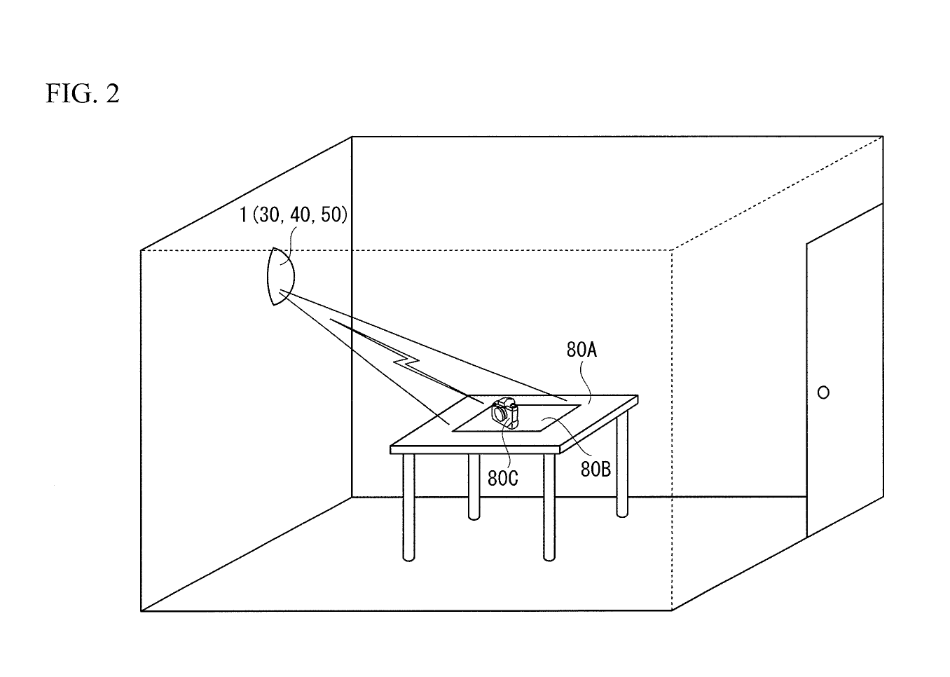

At least the irradiation unit 30 and the image-capturing unit 40 of the electronic controller 1, for example, irradiate specific portions such as a wall surface, a ceiling, a floor surface, a pedestal, and the like which are visible to a person and are attached to an arbitrary portion at which an image of the specific portion is able to be captured. FIG. 2 is a diagram schematically illustrating a state in which the electronic controller 1 is installed in a building. Furthermore, in one example, constituents other than the irradiation unit 30 and the image-capturing unit 40 in the electronic controller 1 are installed (or disposed) at a position separated from the irradiation unit 30 and the image-capturing unit 40, and are able to be connected to the irradiation unit 30 and the image-capturing unit 40 through a wired communication line or by wireless communication. In addition, it is not necessary that the irradiation unit 30 and the image-capturing unit 40 irradiate “only” the specific portion with light and capture an image of “only” the specific portion, and are able to be configured to irradiate a wide region including the specific portion with light and capture an image of the wide region. Alternatively, the irradiation unit 30 and the image-capturing unit 40 are able to be arranged to be separated from each other. The irradiation unit 30, for example, projects an input region 80B having an arbitrary shape such as a rectangular shape, a circular shape, an ellipsoidal shape, or a star-like shape on an arbitrary projection surface such as a top plate surface of a desk 80A in FIG. 2. The input region 80B is projected by light which is visible to the user and indicates an input region of information as described below. FIG. 2 illustrates a state where a digital camera 80C is disposed in the input region 80B.

FIG. 1 will be described again. The communication unit 50 communicates with a communication host other than a communication device 200 through a network 100. In addition, the communication unit 50 is able to have a short distance communication function such as infrared ray communication, Bluetooth (registered trademark), or optical communication using light emitted from the irradiation unit 30. In the communication device 200 illustrated in FIG. 1, an “electronic device having a communication function and a storage device” described below is included. The power supply unit 60 includes a connection member for being connected to a plug installed in a building or a socket for installing a light device. In addition, the power supply unit 60 includes an AC-DC converter converting an alternate current of commercial power into a direct current, and supplies power to the entire electronic controller 1.

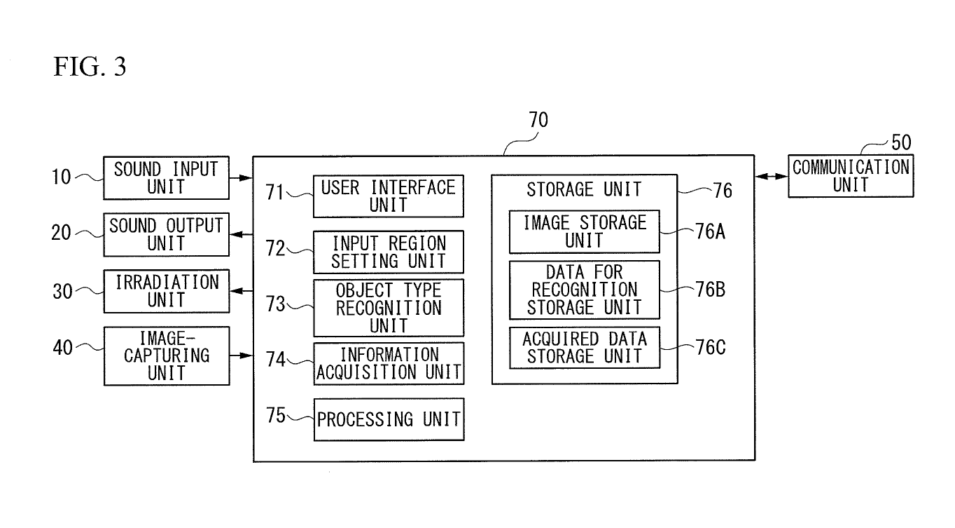

FIG. 3 is a diagram illustrating an example of a functional configuration of the control unit 70. The control unit 70, for example, includes a user interface unit 71, an input region setting unit 72, an object type recognition unit 73, an information acquisition unit 74, a processing unit 75, and a storage unit 76 as a functional unit. The storage unit 76, for example, includes an image storage unit 76A, a data for recognizing storage unit 76B, and an acquired data storage unit 76C.

The user interface unit 71, for example, recognizes the sound of the user input from the sound input unit 10 and converts the sound into text data, and outputs the text data to another functional unit as an indication from the user. In addition, the user interface unit 71 may recognize the indication of the user on the basis of a gesture of the user included in the image captured by the image-capturing unit 40. In addition, the user interface unit 71 generates data for outputting the sound based on a message to the user which is generated by another functional unit, and outputs the data to the sound output unit 20.

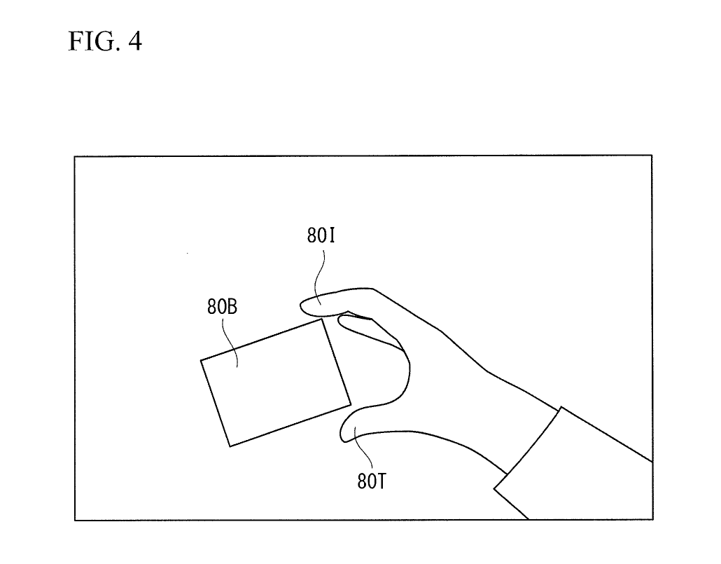

The input region setting unit 72 determines the position and/or the size of the input region 80B (refer to FIG. 2) projected by the irradiation unit 30. The input region setting unit 72, for example, determines the input region 80B by an indication of the fingertip of the user. FIG. 4 is a diagram illustrating a state in which the input region setting unit 72 sets the input region 80B. When the user issues a sound indication such as that through a “cursor” indicating the input region 80B, and performs a specific operation (for example, a gesture) such as putting a hand close to the arbitrary projection surface such as the top plate surface of the desk 80A, the input region setting unit 72, for example, sets a rectangular region, of which one side is set as a line between a thumb 80T and an index finger 801 and an aspect ratio is a predetermined ratio, as the input region 80B. Then, the input region setting unit 72 controls the irradiation unit 30 such that the determined input region 80B is displayed on a projection surface. The input region 80B, for example, is visible on the projection surface by being irradiated with spotlight-like light.

[Object Type Recognition]

The object type recognition unit 73 recognizes the type of the object disposed in the input region 80B. In one example, “disposed in the input region 80B” indicates that the entire object is within the input region 80B. In another example, when part of the object is in the input region 80B, it is considered that the object is disposed in the input region 80B. The object type recognition unit 73, for example, recognizes which type of the object is the type of the object disposed in the input region 80B among candidates of types of a plurality of objects determined in advance.

The object type recognition unit 73, for example, recognizes the type of the object disposed in the input region 80B on the basis of the sound indication (for example, a “camera”, a “name card”, and the like) which is able to specify the object issued by the user. In one example, when the communication unit 50 has a communication function having strong directive properties such as infrared ray communication, the object type recognition unit 73 is able to recognize whether or not the electronic device is an electronic device having a communication function on the basis of whether or not communication directed towards the input region 80B is established. In another example, when the object is an object in which the communication is established, and it is determined that the user in the input region 80B indicates the object from the image captured by the image-capturing unit 40, the object type recognition unit 73 is able to recognize that the electronic device has a communication function. The establishment of the communication only indicates whether or not the object which is a communication partner is in the input region 80B, but the object type recognition unit 73 is able to confirm that the object is in the input region 80B by using the communication having strong directive properties or by recognizing the indication of the user.

Additionally and/or alternatively, the object type recognition unit 73 is able to recognize that the object disposed in the input region 80B is an electronic device having a communication function and a storage device on the basis of the sound indication such as “data” issued by the user (an indication for acquiring data included in the electronic device). When it is recognized that the electronic device is an electronic device having a communication function and a storage device by the sound indication such as the “data”, the information acquisition unit 74 acquires the information stored in the storage device of the electronic device by communicating with the electronic device.

Additionally and/or alternatively, the object type recognition unit 73, as described below, is able to recognize the type of the object on the basis of the presence or absence of the image recognition and/or the communication establishment with respect to the image captured by the image-capturing unit 40. The candidates of the type of the object, for example, include an electronic device having a communication function and/or a storage device, a display medium displaying information on a surface (including an electronic device displaying information, and a paper medium such as a name card, a note, a newspaper, and a magazine), a device having a specific meaning, the hand of the user, and the like. The object type recognition unit 73 recognizes the type of the object disposed in the input region 80B among the candidates by using the information stored in the data for recognizing storage unit 76B. In one example, a function of detecting the shape of the object (a form (a figure, an aspect, a shape, a contour, an outline, a geometric characteristic, a geometric parameter, and/or a graphical model)) as described below is able to be used.

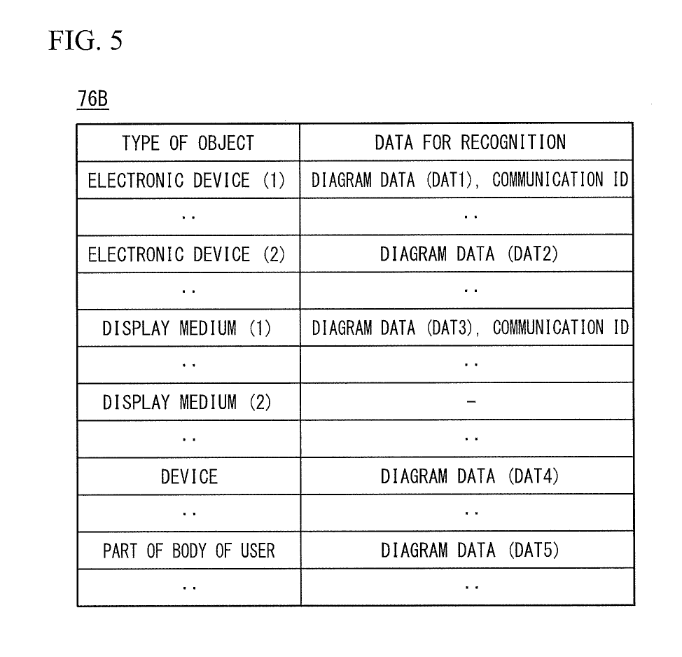

FIG. 5 is a diagram illustrating an example of the information stored in the data for recognizing storage unit 76B. In the example of FIG. 5, an electronic device (1) is an electronic device having a communication function and a storage device, and is an electronic device in which information necessary for communication such as a communication ID is determined. The electronic device (1) corresponds to a camera having a communication function, a mobile phone, a tablet terminal, or the like which is held by the user of the electronic controller 1. For example, the user registers the information of the electronic device (1) such as the communication ID in the electronic controller 1 in advance. In the data for recognizing storage unit 76B, for example, diagram data (DAT1) including a plurality of image data items obtained by capturing an image of the electronic device (1) which is a target from a plurality of directions and the information necessary for the communication such as the communication ID are stored in association with the electronic device (1). Furthermore, when a plurality of electronic devices (1) are registered, the diagram data (DAT1), the communication ID, and the like are registered in each of the electronic devices (1). The same applies to an electronic device (2), display mediums (1) and (2), a device, part of the body of the user. Furthermore, the diagram data (DAT1 to DAT5) is not limited to a captured image (including a two-dimensional model), and may be a three-dimensional model in the shape of an object which is a target. The two-dimensional model and the three-dimensional model, for example, indicate a recognition target through a plurality of straight lines and/or a polygon (each element at the time of expressing an object by combining a triangle and/or a quadrangle), and include coordinates of an end point of each of the straight lines or the size of the polygon, a position of a connection line, a connection angle, and the like.

In addition, in FIG. 5, the electronic device (2) is an electronic device having a communication function and a storage device, and is an electronic device in which the information necessary for the communication such as the communication ID is not determined. In the data for recognizing storage unit 76B, diagram data (DAT2) is stored in association with the electronic device (2). The diagram data (DAT2), for example, is data indicating the exterior appearance of various cameras having a communication function, mobile phones, tablet terminals, or the like which is commercially available.

In addition, in FIG. 5, the display medium (1) is a display medium in a state where information is displayed among the camera, the mobile phone, the tablet terminal, and the like, and is a display medium in which the information necessary for the communication such as the communication ID is determined. In the data for recognizing storage unit 76B, diagram data (DAT3) and the information necessary for the communication such as the communication ID are stored in association with the display medium (1). The diagram data (DAT3), for example, includes a plurality of image data items obtained by capturing an image of the display medium (1) which is a target from a plurality of directions. Furthermore, the same electronic device may be treated as an electronic device or a display medium, and in this case, the electronic controller 1, for example, recognizes whether or not the electronic device functions as the display medium displaying the information on the basis of information transmitted from the electronic device side.

In addition, in FIG. 5, the display medium (2) is a medium such as a name card, a note, a newspaper, or a magazine. In FIG. 5, special data for recognizing is not associated with the display medium (2), and when an approximately rectangular object exists in the input region 80B, and the object is not in any one of the electronic devices (1) and (2), the display medium (1), the device, or part of the body of the user, the object type recognition unit 73, for example, recognizes the object as the display medium (2).

In addition, in FIG. 5, the device, for example, is a device having a specific meaning such as a pen having a predetermined color. The details thereof will be described below. In the data for recognizing storage unit 76B, diagram data 4 is stored in association with the device. The diagram data 4, for example, includes a plurality of image data items obtained by capturing an image of the device which is a target from a plurality of directions.

In addition, in FIG. 5, part of the body of the user, for example, is a hand, the face, the head, and the like of user. In the data for recognizing storage unit 76B, the diagram data 6 is stored in association with part of the body of the user. The diagram data 5, for example, includes a plurality of image data items obtained by capturing an image of part of the body of the user which is a target from a plurality of directions. The diagram data 5 may be a finger print pattern, a palm print pattern, an iris pattern, or the like by which a character is able to be accurately certified, or may be the exterior appearance of part of the body of the user.

In one example, the color and/or the shape of the input region 80B set by the input region setting unit 72 is able to be changed according to the type of the object which is planned to be recognized by the object type recognition unit 73 (for example, to be designated by the user). In this case, for example, the user issues the sound indication (the “camera”, the “name card”, and the like described above) which narrows a range of the type of the object which is planned to be recognized in advance, and the electronic controller 1 displays the input region 80B by the color and/or the shape according to the narrowed range of the type of the object.

[Acquisition of Information Included in Object]

The information acquisition unit 74 acquires information according to the type of the object which is information included in the object of which the type is recognized by the object type recognition unit 73. The information acquisition unit 74 changes the aspect of information to be acquired (for example, a type, a property, a format, an amount, and the like) according to the type of the object which is recognized by the object type recognition unit 73. The aspect of the information is information recorded in a recording device, information of the captured image itself, and textual information and/or numerical information recognized therefrom.

When an object existing in the input region 80B is the electronic device (1), the information acquisition unit 74, for example, acquires the information stored in the storage device of the electronic device (1) by communicating with the electronic device (1), and stores the information in the acquired data storage unit 76C. Accordingly, the user, for example, is able to automatically store photographic data or the like stored in the camera held by the user itself in the storage unit 76 by disposing the electronic device (1) in the input region 80B, and is able to retain the data without performing a bothersome operation. The communication with respect to the object existing in the input region 80B is not limited to communication using electromagnetic waves or an infrared rays, and may be optical communication using light to be emitted for making the input region 80B visible.

In addition, when the object existing in the input region 80B is the electronic device (2), for example, the information acquisition unit 74 tries the communication with respect to the electronic device (2), and when the communication is established, the communication ID is registered in the data for recognizing storage unit 76B and then is treated as the electronic device (1). That is, the information acquisition unit 74 acquires the information stored in the storage device of the electronic device, and stores the information in the acquired data storage unit 76C. In addition, when the communication with respect to the electronic device (2) is not established, the information acquisition unit 74, for example, controls the irradiation unit 30 such that the effect is displayed or the content in which the information of the electronic device (2) is collected from the Internet or the like is displayed. The information of the electronic device (2) may be stored in the acquired data storage unit 76C. In addition, the electronic device (2) in which the communication is not established may be treated as the display medium (2).

In addition, when the object existing in the input region 80B is the display medium (1), the information acquisition unit 74, for example, acquires original data of the information displayed on the display medium (1) by communicating with the display medium (1), and stores the data in the acquired data storage unit 76C. Accordingly, as with the electronic device (1), the user is able to display the electronic content displayed on the tablet terminal or the like held by the user itself on the projection surface of the desk 80A or the like by the irradiation unit 30.

In addition, when the object existing in the input region 80B is the display medium (1), the information acquisition unit 74 may acquire the information displayed on the display medium (1) (a text, an image, and the like) by taking out the information from the image captured by the image-capturing unit 40, and may store the information in the acquired data storage unit 76C. In this case, the information acquisition unit 74 is able to read the text by applying Optical Character Reader (OCR) technology or the like to the image captured by the image-capturing unit 40. Accordingly, the user, for example, is able to browse the enlarged information displayed on the display medium (1) by disposing the display medium (1) in the input region 80B.

In addition, as with the display medium (1), when the object existing in the input region 80B is the display medium (2), the information acquisition unit 74 acquires the information displayed on the display medium (2) by taking out the information from the image captured by the image-capturing unit 40, and stores the information in the acquired data storage unit 76C. In this case, the information acquisition unit 74 is able to read the text by applying the OCR technology or the like to the image captured by the image-capturing unit 40. Accordingly, the user, for example, is able to store information such as a name and contact information described in the name card automatically in the storage unit 76 by disposing the display medium (2) in the input region 80B, and is able to prepare a fictitious name card folder. Similarly, the user is able to prepare a fictitious scrapbook such as a newspaper and a magazine.

In addition, when the object existing in the input region 80B is the device, the information acquisition unit 74 acquires information which is associated with the shape (the form (the figure, the aspect, the shape, the contour, the outline, the geometric characteristics, the geometric parameters, and/or the graphical model)) and/or a hue in advance. For example, when the object existing in the input region 80B is a red pen and a note (the display medium (2)), the information acquisition unit 74 acquires information in which a portion described in red is extracted from information described in the note. Thus, the information acquisition unit 74 acquires the information based on a combination of types of a plurality of objects which is recognized by the object type recognition unit 73, and thus the user is able to perform processing which originally requires a plurality of input operations by disposing the object in the input region 80B. Accordingly, the user is able to use an advanced function which is not included within the scale of an existing device.

In this case, when the recognition in the input region 80B is performed in a sequence of note→red pen, the processing unit 75, for example, controls the irradiation unit 30 such that the acquired information (the information in which the portion described in red is extracted from the information described in the note) described above is projected onto the desk 80A or the like. In contrast, when the recognition in the input region 80B is performed in a sequence of red pen→note, the control unit 75, for example, activates an application or the like in which writing is able to be performed with respect to a note image using a red pen. Additionally and/or alternatively, a sequence of the recognition of the object type recognition unit 73 is able to be determined according to a sequence of the objects positioned in the input region 80B. Thus, the processing unit 75 performs processing based on the combination of the types of the plurality of objects recognized by the object type recognition unit 73 and/or the recognition sequence. Accordingly, the user is able to perform the processing which originally requires a plurality of input operations by disposing the object in the input region 80B.

The processing which is performed by the processing unit 75 on the basis of the combination of the types of the object and/or the recognition sequence may be edited by the user. Thus, the user is able to use the functions of the electronic controller 1 which is highly customized. In addition, such processing may be performed on the basis of the shape and/or the state of the device, and for example, may be performed only when the cap of the red pen is detached.

In addition, when the object existing in the input region 80B is part of the body of the user, the information acquisition unit 74 acquires information in which information relevant to the user is extracted from any information. For example, when the object existing in the input region 80B is the hand of the user and the camera having a communication function (the electronic device (1)), the information acquisition unit 74 acquires photographic data in which photographic data taken by the user is extracted from photographic data acquired by communicating with the camera having a communication function. At the time of extracting the photographic data taken by the user, the information acquisition unit 74 may use a known character certifying method. For example, the information acquisition unit 74 determines whether or not the photographic data is the photographic data taken by the user on the basis of an amount of characteristic in which the size and the position of both eyes in a face image, and a positional relationship among eyes, a nose, and a mouth, an outline, and other elements are digitalized.

The processing unit 75 performs various processing according to the indication of the user input from the user interface unit 71 in addition to the processing described above, and controls the sound output unit 20, the irradiation unit 30, the image-capturing unit 40, the communication unit 50, and the like. For example, the processing unit 75 performs control for projecting a website, a document, and/or a graphic chart, and the like to the projection surface according to the indication of the user or for reading and regenerating music designated by the user from the storage unit 76. In addition, the processing unit 75 may communicate with the electronic device existing in the input region 80B, and may perform processing such as supporting an update of firmware of the electronic device.

[Processing Flow]

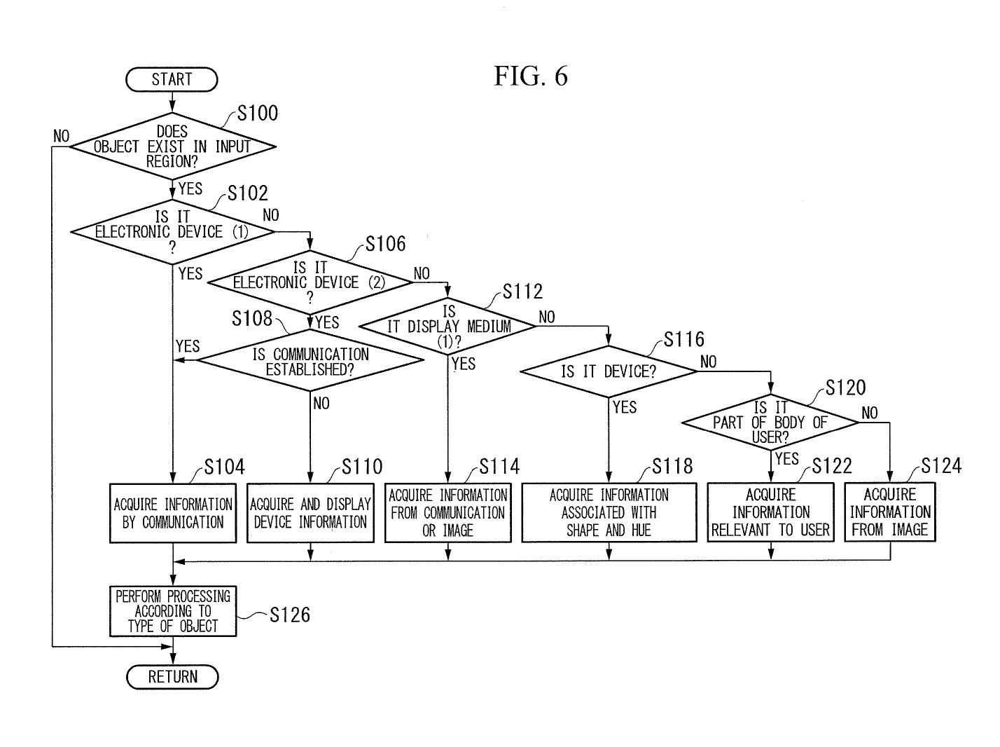

FIG. 6 is an example of a flowchart illustrating a flow of processing executed by the control unit 70 of this embodiment.

First, the control unit 70 determines whether or not the object exists in the input region 80B (Step S100). When the object does not exist in the input region 80B, the control unit 70 ends one routine of a flowchart in FIG. 6.

When the object exists in the input region 80B, the object type recognition unit 73 determines whether or not the object existing in the input region 80B is the electronic device (1) (Step S102). When the object existing in the input region 80B is the electronic device (1), the information acquisition unit 74 acquires the information by communicating with the object existing in the input region 80B (Step S104).

When the object existing in the input region 80B is not the electronic device (1), the object type recognition unit 73 determines whether or not the object existing in the input region 80B is the electronic device (2) (Step S106). When the object existing in the input region 80B is the electronic device (2), the information acquisition unit 74 tries the communication with respect to the object existing in the input region 80B, and determines whether or not the communication is established (Step S108). When the communication with respect to the object existing in the input region 80B is established, the information acquisition unit 74 acquires the information by communicating with the object existing in the input region 80B (Step S104). In contrast, when the communication with respect to the object existing in the input region 80B is not established, the information acquisition unit 74, for example, acquires and displays the device information from the Internet or the like (Step S110).

When the object existing in the input region 80B is not the electronic device (2), the object type recognition unit 73 determines whether or not the object existing in the input region 80B is the display medium (1) (Step S112). When the object existing in the input region 80B is the display medium (1), the information acquisition unit 74 acquires the information from the communication with respect to the object existing in the input region 80B or the image captured by the image-capturing unit 40 (Step S114).

When the object existing in the input region 80B is not the display medium (1), the object type recognition unit 73 determines whether or not the object existing in the input region 80B is the device (or includes the device) (Step S116). When the object existing in the input region 80B is the device, the information acquisition unit 74 acquires the information associated with the shape and/or the hue of the object existing in the input region 80B (Step S118).

When the object existing in the input region 80B is not the device, the object type recognition unit 73 determines whether or not the object existing in the input region 80B is part of the body of the user (or includes part of the body of the user) (Step S120). When the object existing in the input region 80B is part of the body of the user, the information acquisition unit 74 acquires the information relevant to the user (Step S122).

When the object existing in the input region 80B is not part of the body of the user (accordingly, is the display medium (2)), the object type recognition unit 73 acquires the information from the image captured by the image-capturing unit 40 (Step S124).

When the processing of Steps S102 to S124 is performed, the processing unit 75 performs processing according to the type of the object existing in the input region 80B (Step S126). As exemplified above, the processing unit 75 performs processing based on the combination of the types of the plurality of objects recognized by the object type recognition unit 73 and/or the recognition sequence.

[Conclusion]

In the related art, in order to input information into an information processing device or the like, the user manually performs an input operation by using a keyboard and/or a mouse. However, in such an input aspect, there is a problem in that the user has to interpret and input information that the user desires to input for oneself, or the user has to remember the key arrangement of the keyboard or confirm the operation while watching the screen. Accordingly, a user interface for performing such an input aspect is not an intuitive user interface, and thus becomes a complication to information access.

In contrast, the electronic controller 1 of this embodiment recognizes the type of the object existing in the input region 80B, and acquires the information according to the type of the recognized object, and thus it is not necessary that the user performs a bothersome operation such as an indication input, and it is possible to allow the electronic controller 1 to acquire the information by disposing the object including information in the input region 80B. For this reason, the electronic controller 1 is highly convenient.

In addition, the electronic controller 1 of this embodiment acquires the information according to the type of the object, and thus various convenient functions derived from the acquired information are able to be realized.

[Configuration of Irradiation Unit 30 and Image-Capturing Unit 40]

Furthermore, in this embodiment, the irradiation unit 30 and the image-capturing unit 40 are able to be integrally configured by using an optical system in common to both. Hereinafter, a device including the irradiation unit 30 and the image-capturing unit 40 in which the optical system is integrally configured is referred to as an image-capturing irradiation device C1.

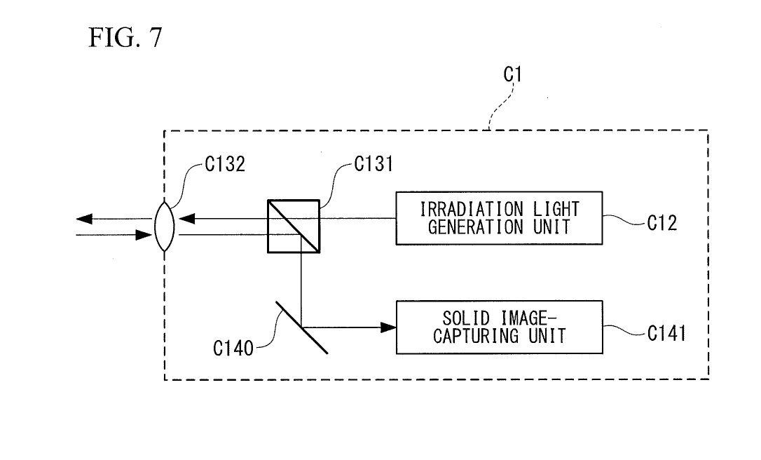

FIG. 7 is a configuration diagram illustrating an example of the configuration of the image-capturing irradiation device C1. In FIG. 7, the image-capturing irradiation device C1 includes an irradiation light generation unit C12, an incident and emitting light separation unit C131, an optical unit C132, and a solid image-capturing unit C141.

The irradiation light generation unit C12 generates light indicating an image to be irradiated on the basis of the control of the control unit 12, and outputs the generated light.

The incident and emitting light separation unit C131 is disposed on an optical path between the optical unit C132 and the irradiation light generation unit C12, and an optical path between the optical unit C132 and the solid image-capturing unit C141. The incident and emitting light separation unit C131 separates an optical path of emitting light emitted to the outside by the image-capturing irradiation device C1 and an optical path of incident light incident to the image-capturing irradiation device C1 from the outside. For example, the incident and emitting light separation unit C131 transmits at least part of the light incident from the irradiation light generation unit C12, and reflects at least part of the light incident from the optical unit C132. The incident and emitting light separation unit C131, for example, is a half mirror, reflects part of the incident light, and transmits a part thereof.

The optical unit C132, for example, is configured of a plurality of lenses. The solid image-capturing unit C141, for example, is a complementary metallic oxide film semiconductor (CMOS) image sensor.

The light output from the irradiation light generation unit. C12 is transmitted through the incident and emitting light separation unit C131, and is emitted through the optical unit C132. On the other hand, the light incident from the outside of the image-capturing irradiation device C1 on the optical unit C132 is reflected on the incident and emitting light separation unit C131, and then is reflected on a reflection unit C140. The light reflected on the reflection unit C140 is incident on the solid image-capturing unit C141, and is converted into data indicating an image by photoelectric conversion. Accordingly, the image-capturing irradiation device C1 is able to use the optical unit C132 in the irradiation and the capturing in common. In addition, the image-capturing irradiation device C1 is able to have the same optical axis in the irradiation and the capturing.

As described above, the image-capturing irradiation device C1 is able to have the same optical axis in the irradiation and the capturing. Accordingly, the control unit 70 is able to recognize an irradiated spot by the captured image of the same optical axis, and thus it is possible to easily adjust the spot. In addition, the image-capturing irradiation device C1 uses the optical system in common, and thus it is possible to reduce a space and it is possible to reduce the cost, compared to a case where the optical system is not used in common. In addition, the light is emitted from the optical system, and thus the user may rarely be conscious of being captured. Accordingly, the user is able to use the electronic controller 1 without being conscious of being captured by the camera.

Furthermore, the image-capturing irradiation device C1 may have a function of independently focusing in the irradiation and the capturing. For example, the image-capturing irradiation device C1 may be provided with a movable lens on the optical path between the optical unit C132 and the irradiation light generation unit C12. In addition, the image-capturing irradiation device C1 may be provided with a movable lens on the optical path between the optical unit C132 and the solid image-capturing unit C141, or the solid image-capturing unit C141 may be movable. Accordingly, the image-capturing irradiation device C1 is able to focus in each of the irradiation and the capturing.

[Hardware Configuration or the Like]

The electronic controller 1 and the communication device 200 of the embodiment described above include a computer system therein. The “computer system” includes hardware such as a Central Processing Unit (CPU), a memory device such as a RAM, a storage device such as a ROM, HDD, and a flash memory, a drive device which is able to mount a storage medium thereon, and a peripheral device.

Then, operation steps of the user interface unit 71 of the electronic controller 1, the input region setting unit 72, the object type recognition unit 73, the information acquisition unit 74, the processing unit 75, and the like, for example, are stored in a recording medium which is able to be read by a computer in a program format, and the program is read by a computer system and is executed, and thus the processing described above is performed. Furthermore, it is not necessary that all of the processes of the respective functional units are performed by executing the program, and part of the functional unit may be realized by hardware such as an Integrated Circuit (IC), Large Scale Integration (LSI), and a network card.

Furthermore, in the embodiment described above, the irradiation unit 30 determines an input range by light to be projected, but alternatively, a display unit such as a display displays the input range, and thus the input range may be determined. As an example in which such a display unit is used, a case where all or part of the top plate surface of the desk 80A in the embodiment described above is configured of a liquid crystal display, a case where a flexible display of an organic EL is attached to a wall surface of a room, and the like are included. In this case, the display unit displays an image in the shape of a circle or a rectangle indicating the input range which is determined on the basis of a specific operation and/or sound of the user. Further, the display unit has a function of displaying not only the light indicating the input range but also the information acquired by the information acquisition unit 74. Furthermore, the display unit and the image-capturing unit 40 configuring the electronic controller 1 may be respectively disposed at separated positions. Then, the electronic controller 1 of another embodiment is able to realize all functions of the embodiment described above by substituting the irradiation unit 30 with the display unit.

Next, another embodiment of the present invention will be described in detail with reference to the drawings.

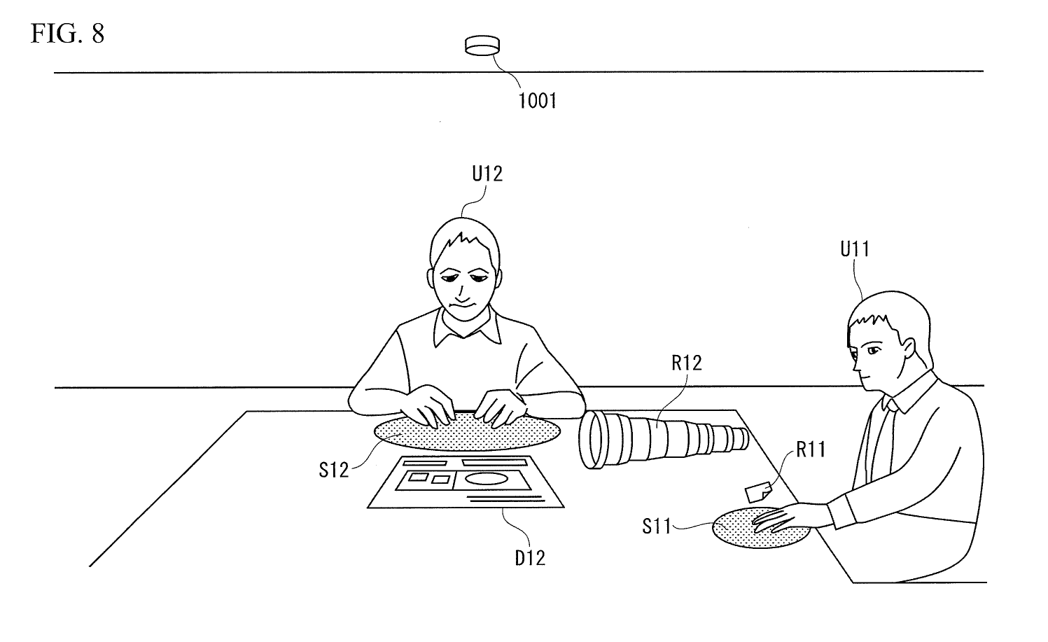

FIG. 8 is a schematic view illustrating a usage example of an electronic controller 1001 according to this embodiment. In this drawing, the electronic controller 1001 is attached to the ceiling of a room. The electronic controller 1001 determines a range in which the information is able to be input (referred to as an information input range) according to the shape of the image-captured object (the form (the figure, the aspect, the shape, the contour, the outline, the geometric characteristics, the geometric parameters, and/or the graphical model)). For example, the electronic controller 1001 determines the information input range according to the shape of the hand of the user. The electronic controller 1001 emits light indicating the determined information input range. In this drawing, spots S11 and S12 appear in a surface to be irradiated which is irradiated with the light. Then, the electronic controller 1001 is able to input the information in the information input range in a state where the light is emitted.

Furthermore, the respective spots may have the same aspect (for example, the size, the color, the pattern, or the shape), or may have aspects which are different from each other. For example, the spots S11 and S12 in FIG. 8 have different sizes and colors.

A user U11 reads the content of a receipt R11 in the electronic controller 1001. Here, the user U11 allows the spot S11 to appear in the electronic controller 1001 according to the shape of one hand. When the user U11 disposes the receipt R11 in the spot S11, the electronic controller 1001, for example, reads the described content of the receipt R11 by textual analysis.

A user U12 investigates information of a product R12 with reference to a display D12 of the electronic controller 1001. Here, the user U12 allows the spot S12 to appear in the electronic controller 1001 according to the shape of both hands. When the user U12 disposes the product R12 in the spot S12, the electronic controller 1001, for example, recognizes a product R12, and acquires information included in the recognized product R12. For example, when the information of the camera is displayed by the display D12, the electronic controller 1001 recognizes that the product R12 is a lens by image analysis. In this case, the electronic controller 1001 acquires information of whether or not there is compatibility between the recognized lens and the camera of the display D12. The electronic controller 1001 notifies the user of the acquired information by using a display and/or a sound.

<Electronic Controller 1001>

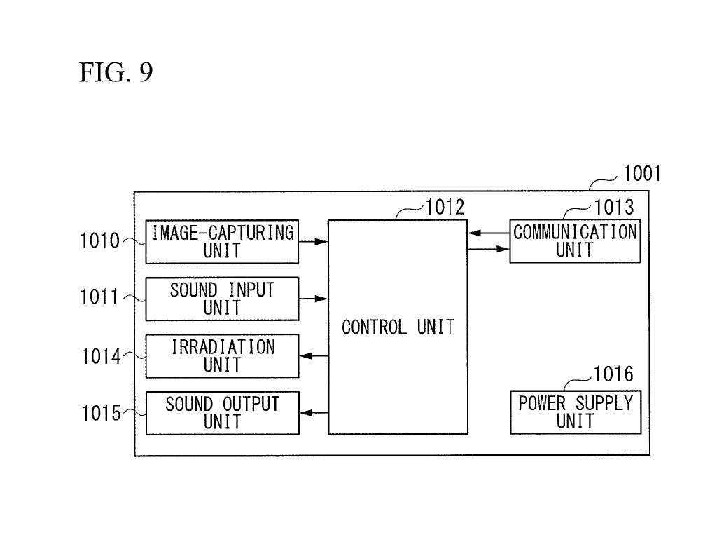

FIG. 9 is a schematic block diagram illustrating the configuration of the electronic controller 1001 according to this embodiment. In this drawing, the electronic controller 1001 includes an image-capturing unit 1010, a sound input unit 1011, a control unit 1012, a communication unit 1013, an irradiation unit 1014, a sound output unit 1015, and a power supply unit 1016.

The image-capturing unit 1010, for example, is a camera. The image-capturing unit 1010 outputs data indicating the captured image to the control unit 1012.

The sound input unit 1011, for example, is a microphone. The sound input unit 1011 converts a sound into data, and outputs the converted data to the control unit 1012.

The control unit 1012, for example, is a central processing unit (CPU) and a storage device. The control unit 1012 performs processing on the basis of the data input from the image-capturing unit 1010 and the sound input unit 1011. For example, the control unit 1012 performs input range determination processing of determining the information input range. In addition, the control unit 1012 acquires the information from the information input range in a state where the light indicating the information input range is emitted, and thus it is possible to input the information in the information input range.

Furthermore, the control unit 1012 may communicate with other devices through the communication unit 1013, and may perform processing on the basis of the information acquired by the communication. The control unit 1012 controls the irradiation unit 1014 and the sound output unit 1015 on the basis of a result of the information processing.

The communication unit 1013 communicates with the other device in a wired or wireless manner.

The irradiation unit 1014, for example, is a projector. The irradiation unit 1014 emits light on the basis of the control of the control unit 1012. Furthermore, the image-capturing unit 1010 and the irradiation unit 1014 may be integrally configured (refer to FIG. 7). Alternatively, the image-capturing unit 1010 and the irradiation unit 1014 are able to be arranged to be separated from each other. The irradiation unit 1014 emits the light indicating the information input range which is determined by the control unit 1012.

The sound output unit 1015, for example, is a speaker. The sound output unit 1015 outputs a sound on the basis of the control of the control unit 1012. Furthermore, the sound output unit 1015 may be a directive properties speaker.

The power supply unit 1016 acquires power from an internal or external power source, and supplies the power to each unit of the electronic controller 1001. The power supply unit 1016, for example, acquires the power through a plug or a socket for installing a light device.

<Input Range Determination Processing>

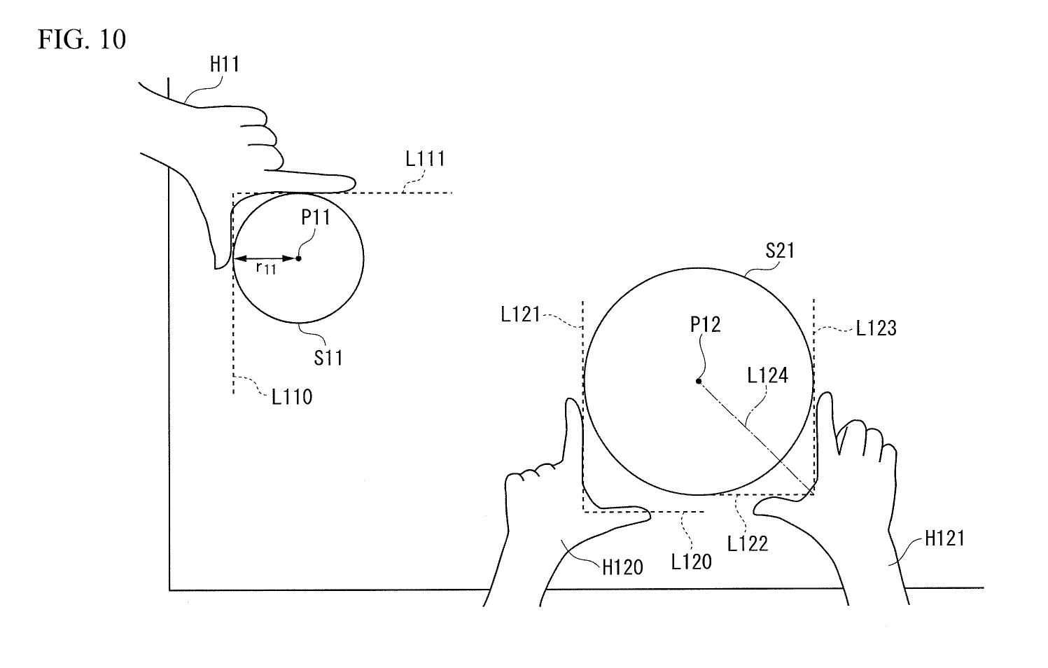

FIG. 10 is a schematic view illustrating an example of input range determination processing according to this embodiment. For example, the user opens a thumb and an index finger into the shape of an L (referred to as an L-shape) while closing a third finger, a fourth finger, and a fifth finger. When the L-shape is detected, the control unit 1012 determines the information input range according to the L-shape.

Specifically, the user U11 designates the information input range by setting one hand H11 into the shape of an L. The control unit 1012 allows two fingers to approximate a straight line (referred to as an approximate straight line) with respect to the hand H11 in the captured image. The control unit 1012 determines a circle which is tangent to the two approximate straight lines as the information input range. For example, the control unit 1012 determines a circle having a predetermined radius r₁₁ which is tangent to a straight line L110 and a straight line L111 as the information input range. The electronic controller 1001 emits the light in the information input range, and thus the spot S11 appears.

Thus, the control unit 1012 detects a line according to the shape of the hand, and determines the position of the information input range according to the two detected lines. Accordingly, the user U11 is able to designate the position of the spot S11 according to the shape of the hand, and is able to input the information in a desired position.

The control unit 1012 may determine the size of the information input range according to the shape of both hands. The user U12 designates the information input range by setting both hands H12 (a left hand H120 and a right hand H121) into the shape of an L. The control unit 1012 allows two fingers to approximate the approximate straight line with respect to each of the hands H120 and H121 in the captured image, and determines a circle which is tangent to three lines of the approximate straight lines as the information input range. For example, the control unit 1012 specifies a bisector L124 of an angle between a straight line L120 and a straight line L121. The control unit 1012 determines a circle having the center on a line L124 and is tangent to the line L121 as the information input range. The electronic controller 1001 emits the light in the information input range, and thus the spot S12 appears.

Thus, the control unit 1012 detects a line according to the shape of the hand, and determines the position and the size of the information input range according to the detected three lines. Accordingly, the user U12 is able to designate the position and the size of the spot S12 according to the shape of the hand, and is able to input the information in a desired position and a desired range of the size.

<Control Unit 1012>

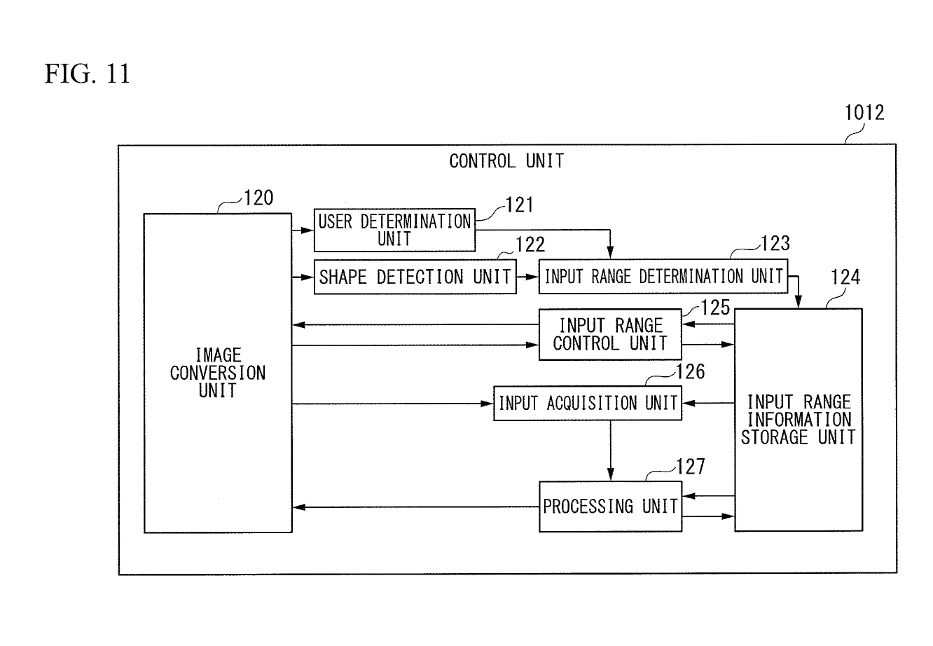

FIG. 11 is a schematic block diagram illustrating the configuration of the control unit 1012 according to this embodiment. In this drawing, the control unit 1012 includes an image conversion unit 120, a user determination unit 121, a shape detection unit 122, an input range determination unit 123, an input range information storage unit 124, an input range control unit 125, an input acquisition unit 126, and a processing unit 127.

The image conversion unit 120 stores mapping information for performing coordinate conversion with respect to the coordinates of the image captured by the image-capturing unit 1010 and the coordinates of the image (referred to as a captured image) used for information processing. In addition, the image conversion unit 120 stores mapping information for performing coordinate conversion with respect to the coordinates of the image irradiated with the light by the irradiation unit 1014 and the image used for the information processing (referred to as an irradiation image). When the captured image and/or the irradiated image are distorted, the mapping information, for example, is information for correcting the distortion.

The image conversion unit 120 converts the image indicated by the data which is input from the image-capturing unit 1010 into the captured image on the basis of the mapping information, and outputs the captured image to the user determination unit 121 and the shape detection unit 122. In addition, the image conversion unit 120 converts the irradiation image indicated by the data which is input from the input range control unit 125 and the processing unit 127 on the basis of the mapping information, and allows the irradiation unit 1014 to irradiate the image after the conversion.

The user determination unit 121 identifies the user in the captured image on the basis of the captured image which is input from the image conversion unit 120, and outputs user identification information of the identified user to the input range determination unit 123. Specifically, the user determination unit 121 recognizes the object from the captured image, and calculates the amount of characteristic (a feature value, and characteristic parameters) of the recognized object. The user determination unit 121 stores a set of the user identification information and the amount of characteristic in advance, and determines whether or not the amount of characteristic which is calculated as any of the stored amounts of characteristic is coincident with the stored amount of characteristic.

When it is determined that the amount of characteristic is coincident with the stored amount of characteristic, the user determination unit 121 determines that the user in the captured image is a user who is registered in advance. In this case, the user determination unit 121 extracts the user identification information in which the amount of characteristic is coincident with the stored amount of characteristic, and outputs the extracted user identification information to the input range determination unit 123.

In contrast, when it is determined that the amount of characteristic is not coincident with the stored amount of characteristic, the user determination unit 121 calculates the amount of characteristic from the user in the captured image. The user determination unit 121 generates new user identification information, and stores a set of the generated user identification information and the calculated amount of characteristic. In this case, the user determination unit 121 outputs the generated user identification information to the input range determination unit 123.

The shape detection unit 122 detects a spot irradiation indication on the basis of the captured image which is input from the image conversion unit 120. The spot irradiation indication, for example, is a specific gesture of the user (for example, a body gesture, and a hand gesture), and is an indication which requires the appearance of the spot, that is, the input of the information. Specifically, the shape detection unit 122 stores the amount of characteristic in advance with respect to the shape of the object indicating the spot irradiation indication (referred to as a shape of an irradiation indication). The shape detection unit 122 detects a portion having an amount of characteristic which is identical to or approximate to the amount of characteristic from the captured image, and thus detects the spot irradiation indication. When the spot irradiation indication is detected, the shape detection unit 122 outputs the information indicating the detected the shape of the irradiation indication to the input range determination unit 123.

The input range determination unit 123 determines the information input range according to the shape of the irradiation indication indicated by the information which is input from the shape detection unit 122. For example, the input range determination unit 123 determines a part or all of the position, the size, the shape, the color, or the pattern of the information input range according to the shape of the irradiation indication. The input range determination unit 123 associates the user identification information input from the user determination unit 121 with the information indicating the determined information input range, and stores the associated information (referred to as the input range information) in the input range information storage unit 124.

The input range control unit 125 generates an irradiation image including the image of the light indicating the information input range on the basis of the input range information stored in the input range information storage unit 124. The input range control unit 125 outputs the generated irradiation image to the image conversion unit 120. Accordingly, the irradiation unit 1014 emits the light indicating the information input range, and thus the spot appears. In addition, the input range control unit 125 may adjust the information input range according to the captured image and the input range information, and thus may change the position and/or the size of the spot.

The input acquisition unit 126 specifies the spot in the processing image, that is, the information input range according to the captured image and the input range information. The input acquisition unit 126 acquires the image in the spot from the captured image.

The processing unit 127 acquires the information included in the object in the spot on the basis of the image acquired by the input acquisition unit 126. That is, the processing unit 127 acquires the information of the object which is recognized in the information input range. For example, the processing unit 127 acquires the image of the object in the spot. In addition, for example, the processing unit 127 may acquire the amount of characteristic of the object in the spot. In addition, for example, the processing unit 127 may perform textual analysis, and may acquire textual document data described in the object in the spot.

The processing unit 127 may specify the object in the spot on the basis of the acquired image, the amount of characteristic, or the document data, and may acquire the information relevant to the object (a trade name or the like). In addition, for example, the processing unit 127 may print the acquired image or document data. In addition, the processing unit 127 may acquire a search result of searching the Internet on the basis of the acquired image or document data, or may generate an e-mail with the captured image attached in which the document data is a body of text.

The processing unit 127 may generate the irradiation image on the basis of the acquired information. Accordingly, the irradiation unit 1014 is able to display the information on the basis of the information acquired by the processing unit 127. Here, the processing unit 127 may display the information in the position and the size deviated from the information input range according to the input range information. Accordingly, the electronic controller 1001 is able to prevent the display from being hardly seen by superimposing the spot on the irradiated display. In addition, the processing unit 127 may generate sound data on the basis of the acquired information. The electronic controller 1001 is able to output a sound on the basis of the information acquired by the processing unit 127.

<Operation>

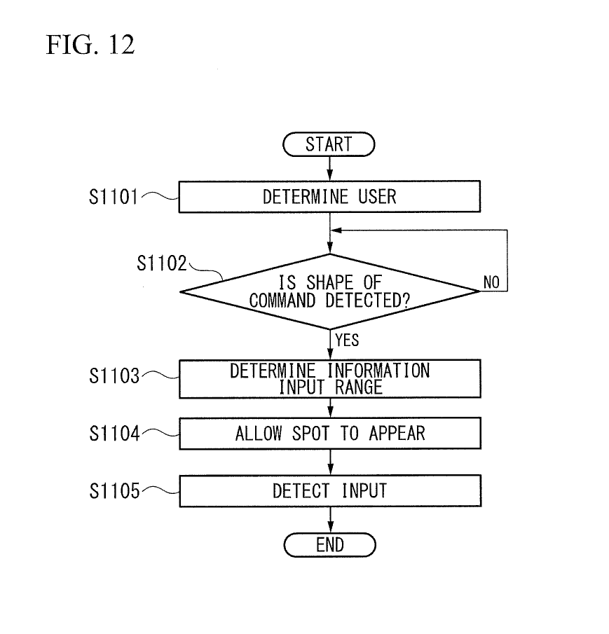

FIG. 12 is a flowchart illustrating an example of the operation of the electronic controller 1001 according to this embodiment.

(Step S1101)

The user determination unit 121 determines the user on the basis of the amount of characteristic of the user in the captured image. Furthermore, when a new user is detected, the user determination unit 121 generates and registers the new user identification information. After that, the processing proceeds to Step S1102.

(Step S1102)

The shape detection unit 122 determines whether or not the shape of the irradiation indication is detected, and thus determines whether or not the user determined in Step S1101 performs the spot irradiation indication. After that, the processing proceeds to Step S1103.

(Step S1103)

The input range determination unit 123 determines the information input range according to the shape of the irradiation indication detected in Step S1102. After that, the processing proceeds to Step S1104.

(Step S1104)

The input range control unit 125 allows the irradiation unit 1014 to emit the light indicating the information input range determined in Step S1103. Accordingly, the spot appears. After that, the processing proceeds to Step S1105.

(Step S1105)

The input acquisition unit 126 acquires the image in the spot. The processing unit 127 acquires the information included in the object in the spot on the basis of the image acquired by the input acquisition unit 126. After that, the processing ends. However, after Step S1105 ends, the processing may return to Step S1102, or the processing of Step S1105 may be periodically continued.

As described above, in this embodiment, the control unit 1012 determines the information input range according to the shape of the object. The irradiation unit 1014 emits the light indicating the information input range, and thus the spot appears. Accordingly, the user is able to confirm the information input range by observing the spot. In addition, the user is able to designate the spot according to the shape of the object, and is able to input the information in the designated spot. In addition, the control unit 1012 detects a gesture (for example, the user sets the hands into the shape of the irradiation indication), and determines the information input range according to the detected gesture. Accordingly, the user, for example, is able to designate the spot according to the gesture without grasping and operating a specific electronic device, and is able to input desired information in the designated spot.

In addition, the control unit 1012 determines the position and the size of the information input range according to the shape of the object. Accordingly, the user is able to designate the position and the size of the spot according to the shape of the object, and is able to input the information in a range of the designated position or size.

For example, in FIG. 8, the users U11 and U12 are able to designate the position or the size of each of the spots S11 and S12 according to the shape of the hand. Furthermore, in the user U11, the receipt R11 is smaller than the product R11, and thus the spot S11 which is smaller than the spot S11 appears. The user sets the spot S11 and the receipt R11 to have the approximately same size (a depth, a range, an area, or a width), and thus it is possible to prevent other objects from being included in the spot S11, and it is possible to prevent the electronic controller 1001 from reading the information of the other object.

In addition, the control unit 1012 detects the straight line according to the shape of the object, and determines the position or the size of the information input range according to at least two straight lines among the detected straight lines. Thus, the control unit 1012 determines the position or the size according to the straight line, and thus the position or the size is able to be determined at a low load, as compared to a curved line.

The control unit 1012 acquires the information included in the object in the information input range. Accordingly, the user is able to easily acquire the information included in the object. In addition, the information input range is indicated, and thus the user is able to acquire the information only included in a desired object or a portion of the object.

### First Modification Example

The control unit 1012 may determine the position and the size of the information input range according to the shape of one hand of the user. For example, the user designates position of the spot by the fingertip, and designates the size of the spot by a distance between two fingers.

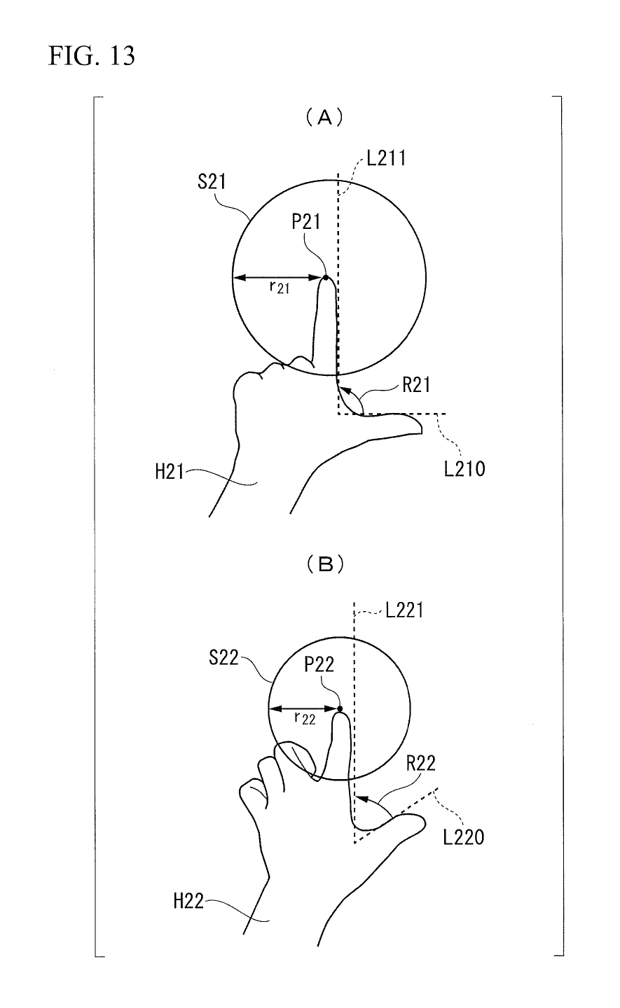

FIG. 13 is a schematic view illustrating an example of input range determination processing according to a first modification example of this embodiment.

A spot S21 in FIG. 13(A) is an example of a spot which appears according to the shape of a hand H21. A spot S22 in FIG. 13(B) is an example of a spot which appears according to the shape of a hand H22. The control unit 1012 determines a tip end of an index finger of the user as the center (or the gravity center) of the information input range. In FIG. 13, the centers P21 and P22 of the spots S21 and S22 are on the tip end of the index finger.

The control unit 1012 determines the information input range according to the distance between the thumb and the index finger. Specifically, the control unit 1012 stores an angle between an approximate straight line of the thumb and an approximate straight line of the index finger, and information associated with the radius of a circle in advance. The control unit 1012 detects the information, and the angle between the approximate straight line of the thumb and the approximate straight line of the index finger, and determines the radius of the circle according to the detected angle. For example, the control unit 1012 increases the information input range as the detected angle becomes larger, and conversely decreases the information input range as the detected angle becomes smaller. In FIG. 13, an angle R22 between a line L220 and a line L221 is smaller than an angle R21 between a line L210 and a line L211. For this reason, a radius r₂₂ of the spot S22 is smaller than a radius r₂₁ of the spot S21.

Thus, the control unit 1012 detects a plurality of straight lines relevant to the shape of the object, and determines the size of the information input range according to a positional relationship in the respective straight lines. In addition, the control unit 1012 determines a circle which is tangent to two straight lines as the information input range. Furthermore, the control unit 1012 may determine a diagram (for example, a polygon) which is tangent to two straight lines as the information input range.

Furthermore, when the user changes the distance between the thumb and the index finger after the spot appears, the control unit 1012 may change the size of the spot which has appeared. Accordingly, the user is able to adjust the size of the spot while observing the spot which has appeared.

The control unit 1012 may determine the radius of the information input range as r₂×R2/90. Here, r₂ is a reference value of the radius, and R2 is the angle between the approximate straight line of the thumb and the approximate straight line of the index finger. In addition, the control unit 1012 may determine r₂ according to the length of the index finger, and for example, may set the length from a root portion to a tip end of the index finger as r₂.

### Second Modification Example

The control unit 1012 may remove the information input range according to the shape of the object (referred to as input range removal processing). The control unit 1012 stores the amount of characteristic of the shape of a removal indication in advance with respect to the shape of the object relevant to a spot removal indication (referred to as the shape of the removal indication). The control unit 1012 detects a portion having an amount of characteristic which is identical to or approximate to the amount of characteristic from the captured image, and thus detects the spot removal indication. For example, the user sets the back of the hand to be downward (a side opposite to the electronic controller 1001), and sets the palm to be upwards (the electronic controller 1001 side), and thus performs the spot removal indication.

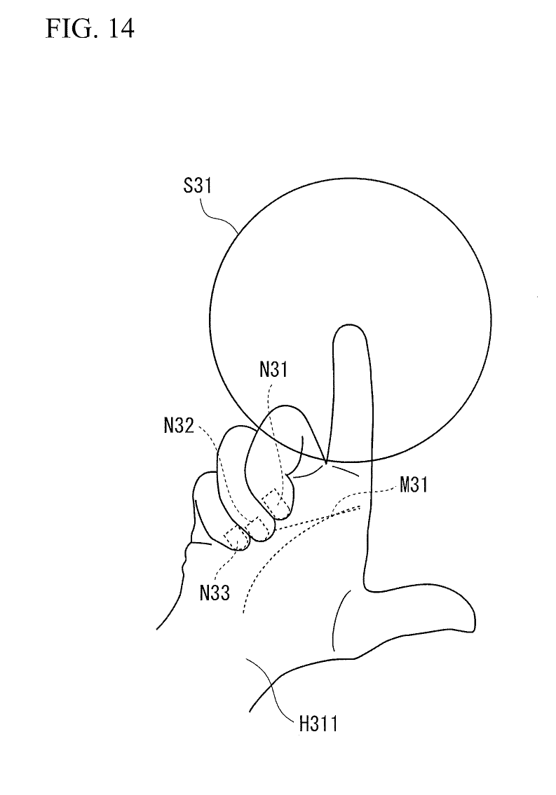

FIG. 14 is a schematic view illustrating an example of input range removal processing according to a second modification example of this embodiment. In this drawing, a hand H311 has the shape of the removal indication which is a shape where the front side and the back side of the hand are inverted while maintaining the shape of the irradiation indication. The control unit 1012 detects an amount of characteristic indicating nails N31, N32, and/or N33, and/or an amount of characteristic indicating a line (a life line) of the flat portion of the hand, and thus detects the spot removal indication. In this case, the control unit 1012 removes a spot S31 including at least part of the shape of the removal indication. Thus, the control unit 1012 removes the information input range by the specific gesture. Accordingly, the user is able to remove the spot.

In addition, as another example of the input range removal processing, an aspect is included in which in a state where a spot S31 is displayed, the spot S31 gradually decreases as the angle between the thumb and the index finger becomes narrower, and the spot S31 is removed at a time point when the fingertip of the thumb is in contact with the fingertip of the index finger. Thus, the control unit 1012 may perform the input range removal processing when the fingers which designate the position or the size of the spot are in contact with each other or intersect with each other. In addition, when the size of the information input range is able to be adjusted according to the shape of the object, the control unit 1012 may perform the input range removal processing at the time that the information input range has no size or a size which is smaller than a predetermined size.

Furthermore, when the spot removal indication is detected, the control unit 1012 may removal only the information input range which is indicated by the shape of the removal indication. In addition, when the spot removal indication is detected, the control unit 1012 may remove the entire information input range of the user who performs the spot removal indication.

### Third Modification Example

The shape of the irradiation indication and/or the shape of the removal indication may not be an L-shape. In addition, the control unit 1012 may detect a surface according to the shape of the object, and may determine the information input range according to a side of the detected surface. In addition, the control unit 1012 may detect a line or a side according to the shape of the object, and may determine the information input range according to the detected line or a diagram configured of the side.

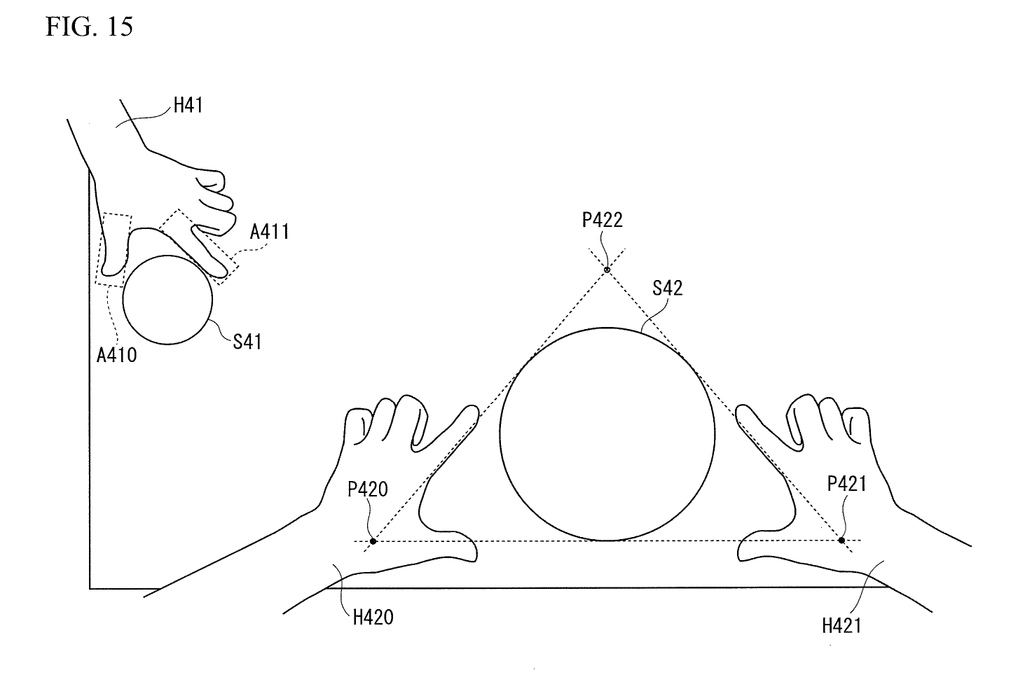

FIG. 15 is a schematic view illustrating an example of input range determination processing according to a third modification example of this embodiment. In this drawing, hands H41, H420, and H421 are in an L-shape, and the distance between the thumb and the index finger is narrower than that of the L-shape. The control unit 1012 detects surfaces A410 and A411 according to the shape of the hand H41. The control unit 1012 determines the information input range according to a side of the detected surface A410 and a side of the detected surface A411, and thus a spot S41 appears. Thus, the control unit 1012 may detect the surface according to the shape of the object, and may determine the position or the size of the information input range according to at least two sides among the sides of the detected surface.

The control unit 1012 detects the root portion of the thumb and the index finger (points P420 and P421) according to the shape of the hands H420 and H421, and detects an intersection point P422 in a direction indicated by the index finger from the root portion. The control unit 1012 determines a diagram (an inscribed circle in FIG. 15) inscribed in a triangle which connects the points P420, P421, and P422 as the information input range, and thus a spot S42 appears. Furthermore, the control unit 1012 may determine a diagram (for example, a circumscribed circle) circumscribed on the triangle as the information input range.

### Fourth Modification Example

The control unit 1012 may detect a curved line according to the shape of the object, and may determine the information input range according to the detected curved line.

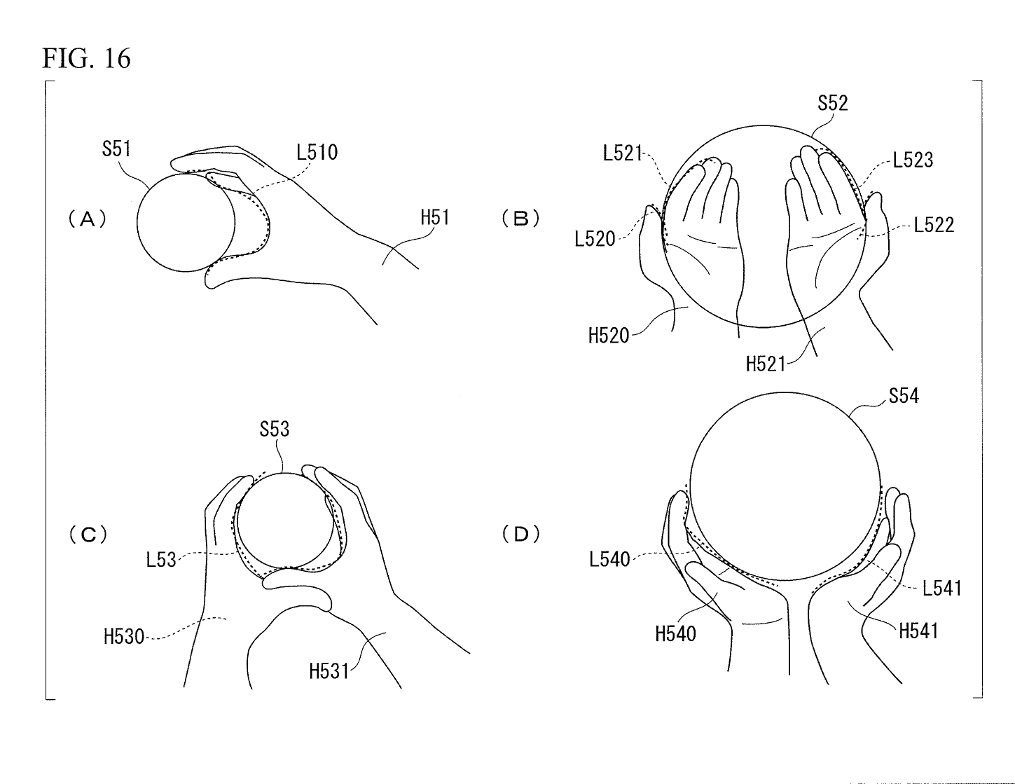

FIG. 16 is a schematic view illustrating an example of input range determination processing according to a fourth modification example of this embodiment. In this drawing, the user bends the finger.

In FIG. 16(A), the control unit 1012 detects a line L510 according to the shape of a hand H51. The control unit 1012 determines a circle which is tangent to the line L510 as the information input range, and thus a spot S51 appears. Furthermore, as illustrated in FIG. 16(A), the control unit 1012 may allow the spot S51 to appear such that the spot S51 is not superimposed on the hand H51.

In FIG. 16(B), the control unit 1012 detects lines L520 and L521 according to a shape of a hand H520, and detects lines L522 and L523 according to a shape of a hand H521. Here, the lines L520 and L522 indicate the outline of the thumb, and the lines L521 and L523 indicate the outline of the index finger. The control unit 1012 determines a circle which is tangent to the lines L521 and L523 indicating the outline of the index finger as the information input range, and thus a spot S52 appears. Furthermore, as illustrated in FIG. 16(B), the control unit 1012 may allow the spot S52 to appear such that the spot S52 may be superimposed (circumscribed) on a range excluding the thumb among the hands H520 and H521. In addition, the control unit 1012 may allow the spot S52 to appear such that the spot S52 is superimposed on the entirety of the hands H520 and H521 including the thumb.

(C1.7: Determination of Diagram Approximating to Curved Line)

In FIG. 16(C), the control unit 1012 detects a line L53 according to a combined shape of both hands H530 and H531. The control unit 1012 determines a circle which is tangent to the line L53 as the information input range, and thus a spot S53 appears.

In FIG. 16(D), the control unit 1012 detects a line L540 according to a shape of a hand H540, and detects a line L541 according to a shape of a hand H541. The control unit 1012 determines a circle which is tangent to the lines L540 and L541 as the information input range, and thus a spot S54 appears.

As with the spots S53 and S54, the control unit 1012 may determine the information input range according to the degree at which both of the hands of the user are opened. In addition, as illustrated in FIG. 16, the control unit 1012 may position the information input range not on the back side of the hand, but on the flat portion of the hand.

In addition, the control unit 1012 may detect the curved line relevant to the shape of the object, and may determine a diagram approximating to the detected curved line as the information input range. For example, in FIG. 16, the control unit 1012 determines a circle approximating to the curved line rather than a polygon as the information input range. In contrast, as illustrated in FIG. 10, when the straight line is detected, the control unit 1012 may determine a polygon (for example, a quadrangle) as the information input range. Furthermore, the approximation, for example, indicates that the shape of part of the curved line is identical to the shape of part of the edge of the diagram (including the similar shape), or may indicate that the number of portions having the same shape increases and/or the sum of the lengths of the portions having the same shape increases. In addition, the approximation may indicate that the diagram is tangent to the curved line, or may indicate that the number of contact points increases and/or the sum of the lengths of the portions tangent to the curved line increases.

### Fifth Modification Example

The control unit 1012 may change the position and/or the size of the spot when the spot appears.

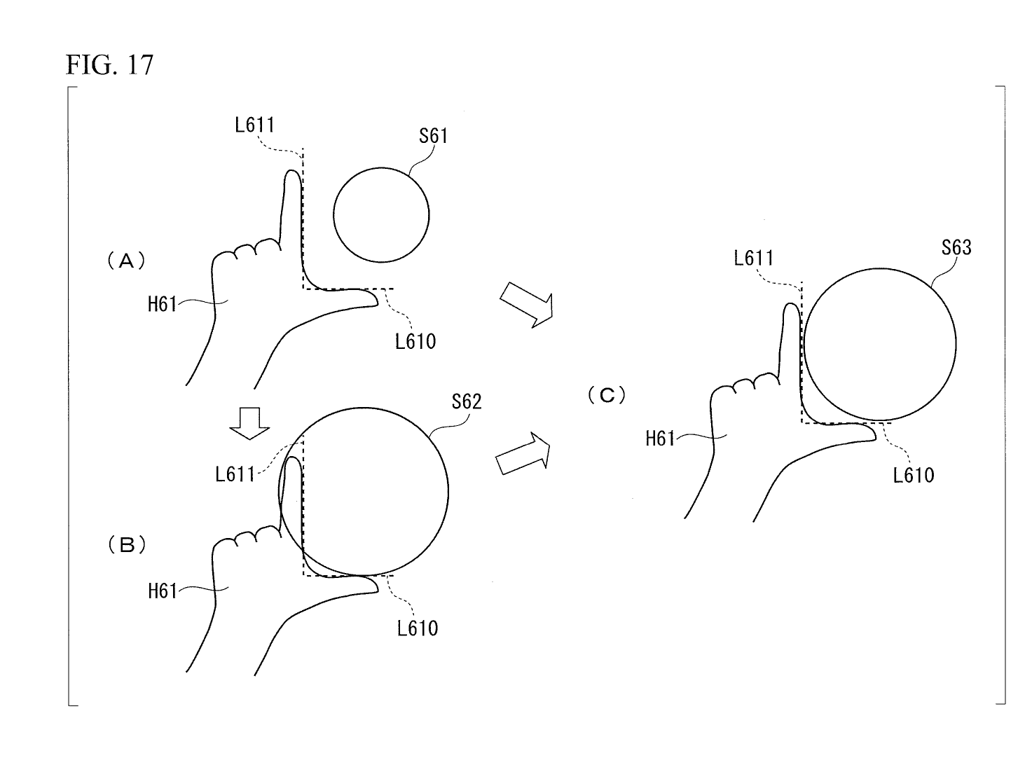

FIG. 17 is a schematic view illustrating an example of processing of an electronic controller 1001 according to a fifth modification example of this embodiment.

A spot S61 in FIG. 17(A) is an example of a spot which appears initially. A spot S62 in FIG. 17(B) is an example of a spot which appears in mid-flow. A spot S63 in FIG. 17(C) is an example of a spot which appears finally.

In FIG. 17(A), the control unit 1012 allows the spot S61 which is smaller than the determined information input range to appear. After that, the control unit 1012 changes the size of the spot S61 to gradually increase. As a result thereof, in FIG. 17(C), the control unit 1012 detects that the spot is tangent to the lines L610 and L611, and ends the change when the spot S63 appears.

In contrast, as a result of changing the size of the spot S61, when the spot is not tangent to the lines L610 and L611, the control unit 1012 may adjust the position or the size of the information input range. In FIG. 17(B), when it is detected that the spot S62 exceeds the line L611, the control unit 1012 changes the position or the size of the information input range. As a result thereof, in FIG. 17(C), the control unit 1012 determines that the spot is tangent to the lines L610 and L611, and ends the change when the spot S63 appears.

Thus, the control unit 1012 gradually changes the information input range, and thus it is possible to adjust a shift between the spot and the information input range, and it is possible to allow the spot to be coincident with the information input range.

### Sixth Modification Example

The control unit 1012 may determine the shape of the information input range as an arbitrary shape (for example, a polygonal shape, a star-like shape, and a shape registered by the user). For example, the control unit 1012 registers a heraldic emblem of the individual user, and the aspect of the heraldic emblem may be the aspect of the information input range. Accordingly, the user is able to intuitively understand that the spot is a user's own spot while observing the aspect of the spot. In addition, the control unit 1012 may determine the position, the size, the direction, or the shape of the information input range according to the shape of the object.

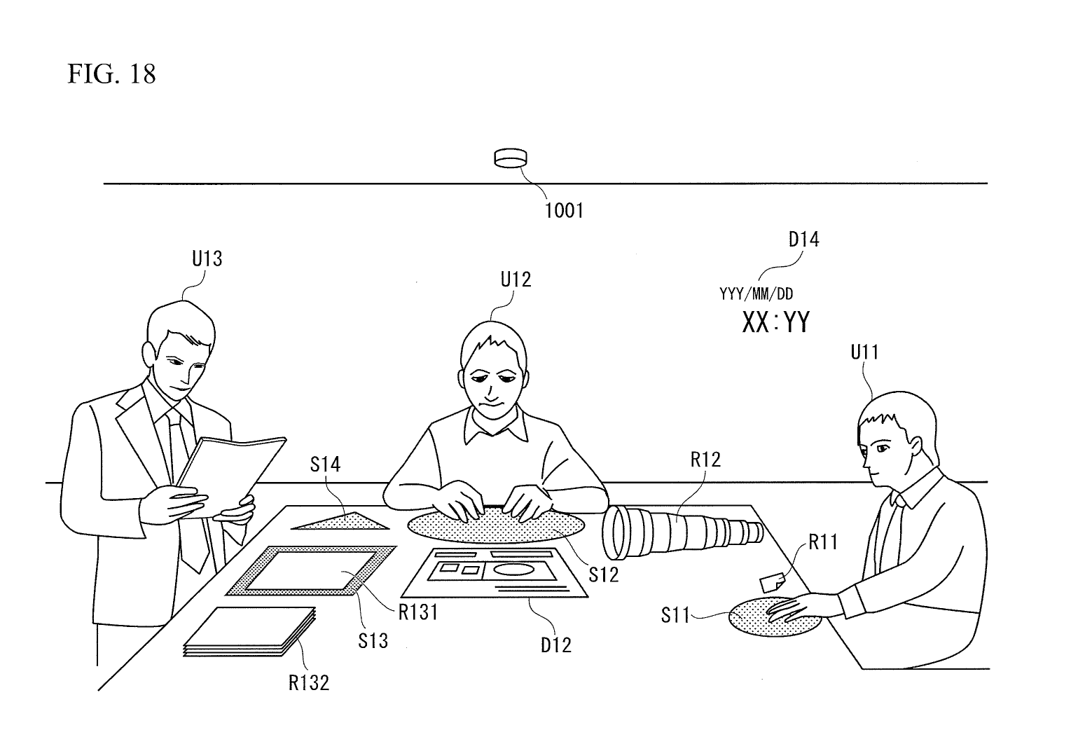

FIG. 18 is a schematic view illustrating another usage example of the electronic controller 1001 according to a sixth modification example of this embodiment. In this drawing, the spots S11 and S12 are identical to those of FIG. 8.

A user U13 tries to copy an information material. Here, the user U13 allows the spot S13 to appear in the electronic controller 1001. The electronic controller 1001 captures an image of an information material R131, and prints the captured image of the information material R131 by using a printer or copier (not illustrated). The information input range is indicated by the spot S13, and thus the user U13, for example, is able to dispose only the information material R131 which is a copy target in the spot S13, is able to dispose an information material R132 which is not a copy target out of the spot S13, and is able to copy only the information material R131. In addition, the user U13 sets the spot S13 into the shape of a rectangle which is identical to that of the information material R131 and into a shape which is similar to that of the object disposed in the region. Accordingly, the user U13 is able to copy the information material R132 in a narrower position compared to a case where the spot S13 is in a shape which is not similar to that of the object (for example, a circle), and a region other than the spot S13 is able to be widely utilized.

In addition, the user U13 allows a spot S14 different from the spot S12 to newly appear. The spot S14 has the shape of a triangle, and is able to exert a function which is identical to or different from that of the spot S12.

Furthermore, as with the spots S11, S12, and S13, the spots may have functions exerted in the region which are different from each other.

In addition, the electronic controller 1001 may separate a region in which the spot is able to appear from a region in which the spot is not able to appear. For example, the electronic controller 1001 sets a wall of a room as a region in which a display (for example, a display D14) is performed, and may set the wall of the room as a region in which the spot is not able to appear.

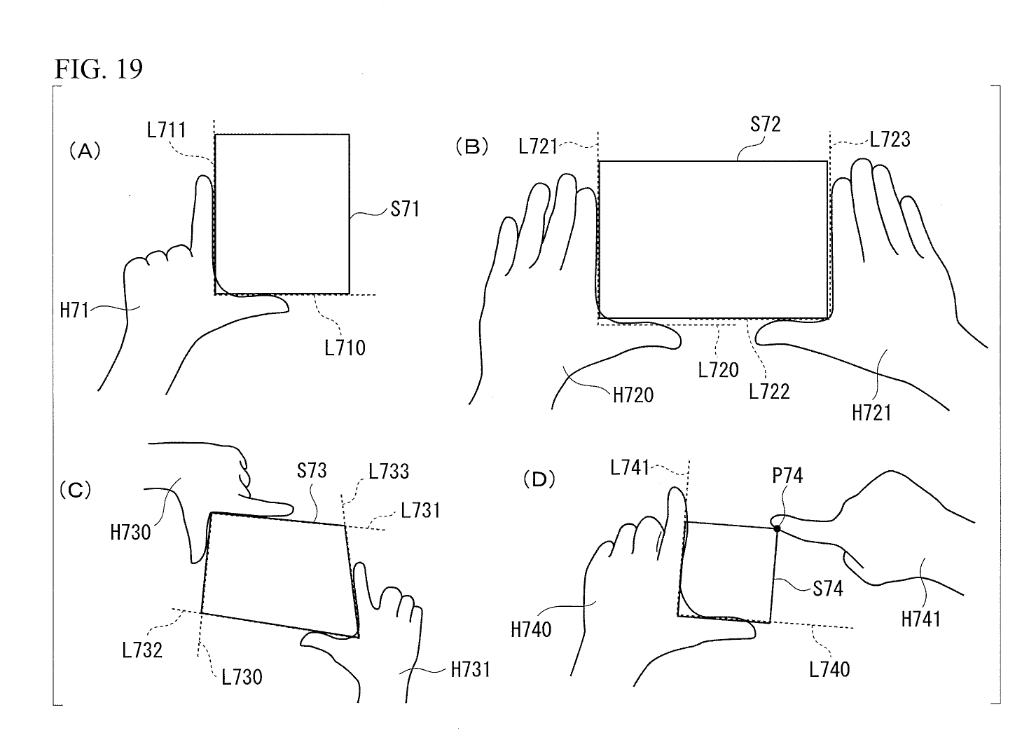

FIG. 19 is a schematic view illustrating an example of input range determination processing according to the sixth modification example of this embodiment.

In FIG. 19(A), the control unit 1012 detects lines L710 and L711 according to the shape of a hand H71. The control unit 1012 determines a quadrangle which is tangent to the lines L710 and L711 as the information input range, and thus a spot S71 appears. Here, the control unit 1012 sets part of the lines L710 and L711 as two sides of the quadrangle, and thus determines the direction of the information input range. Furthermore, the control unit 1012 may set the length of the two sides of the quadrangle to a predetermined length.

In FIG. 19(B), the control unit 1012 detects lines L720 and L721 according to the shape of a hand H720, and detects lines L722 and L723 according to the shape of a hand H721. The control unit 1012 determines a quadrangle which is tangent to the lines L721, L722, and L723 as the information input range, and thus a spot S72 appears. Here, the control unit 1012 may set the length of one side of the quadrangle to a predetermined length.

Furthermore, the control unit 1012 does not set the line L720 as a tangent line of the information input range, and sets the line L721 as one of the tangent lines of the information input range. For example, the control unit 1012 sets a tangent line which is separated from the head or the body of the user as one of the tangent lines of the information input range. Accordingly, the control unit 1012 is able to prevent at least part of the hand H721 from being included in the spot.

In FIG. 19(C), the control unit 1012 detects lines L730 and L731 according to the shape of a hand H730, and detects lines L732 and L733 according to the shape of a hand H731. The control unit 1012 determines a quadrangle which is tangent to the lines L730 to L733 as the information input range, and thus a spot S73 appears. Thus, the control unit 1012 may determine the shape of the information input range by setting part of the lines L730 to L733 as four sides of the quadrangle.

In FIG. 19(D), the control unit 1012 detects lines L740 and L741 according to the shape of a hand H740, and detects a point P74 according to the shape of a hand H741. The control unit 1012 determines a quadrangle (for example, a parallelogram) which is tangent to the lines L740 and L741, and sets a point P74 as one of vertexes as the information input range, and thus a spot S74 appears. Furthermore, the control unit 1012 may determine a quadrangle (for example, a parallelogram) which is tangent to the lines L740 and L741, and sets the point P74 as the center of gravity as the information input range.

### Seventh Modification Example

The control unit 1012 may determine the information input range according to an object indicated by the user and/or a carried article of the user.

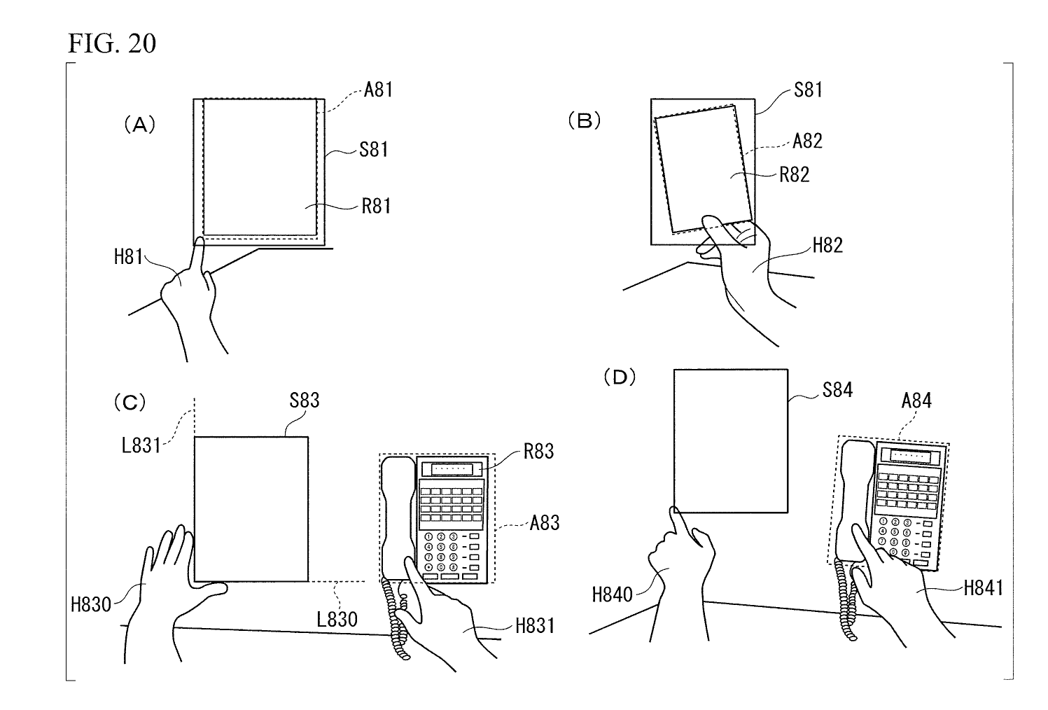

FIG. 20 is a schematic view illustrating an example of input range determination processing according to a seventh modification example of this embodiment.

In FIG. 20(A), the control unit 1012 detects a shape A81 of an information material R81 indicated by a hand H81. The control unit 1012 determines a range surrounding the shape A81 as the information input range, and thus a spot S81 appears. Here, the control unit 1012 sets the information input range into a rectangular shape which is identical to that of the information material R81, and is similar to that of the information material R81.

In FIG. 20(B), the control unit 1012 detects a shape A82 of paper R82 which is held by a hand H82 of the user. The control unit 1012 determines a range surrounding the shape A82 as the information input range, and thus a spot S82 appears.

In FIG. 20(C), the control unit 1012 detects a shape A83 of a telephone set R83 indicated by a right hand H831, and determines the shape and the size of the information input range according to the shape A83. Here, the control unit 1012 determines the shape and the size of the information input range as the shape and the size which are able to surround the shape A83. In addition, the control unit 1012 detects lines L830 and L831 according to the shape of a left hand H830, and determines a position which is tangent to the lines L830 and L831 as the position of the information input range. The control unit 1012 allows a spot S83 to appear according to the determined position, shape, and size.

In FIG. 20(D), the control unit 1012 detects a shape A84 of a telephone set R84 indicted by a right hand H841, and determines the shape and the size of the information input range according to the shape A84. In addition, the control unit 1012 detects a point P84 according to the shape of a left hand H840, and determines a position in which the point P84 is one of the vertexes as the position of the information input range. The control unit 1012 allows a spot S84 to appear according to the determined position, shape, and size.

Thus, control unit 1012 may determine the shape and/or the size of the information input range according to an object indicated by one hand or an object carried by the user, and may determine the position of the information input range according to the shape of the other hand.

### Eighth Modification Example

The control unit 1012 may notify information indicating a function which is exerted in each spot, and/or information indicating that a function is in the middle of being exerted by using a display and/or a sound. In addition, the control unit 1012 may display an icon and/or a menu in each of the spots or on the vicinity of each of the spots.

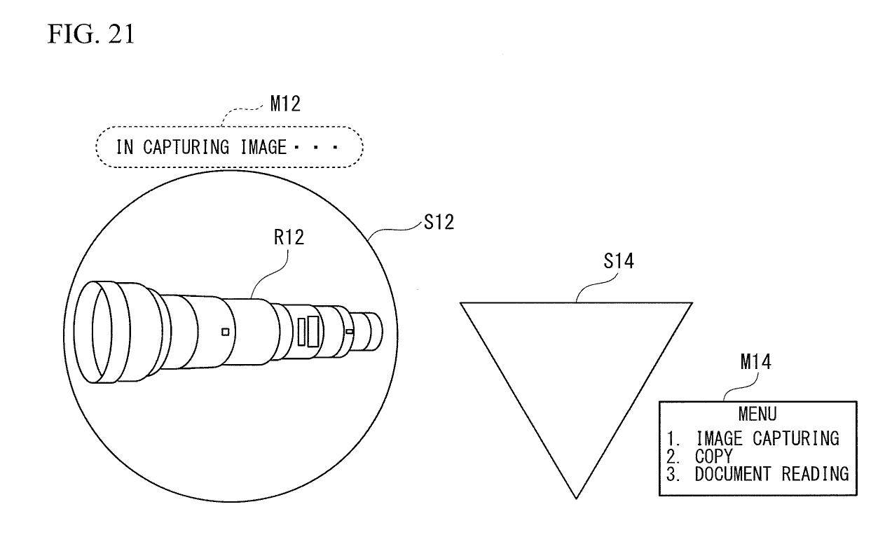

FIG. 21 is a schematic view illustrating an example of a display according to an eighth modification example of this embodiment.

The electronic controller 1001 captures an image of the product R12 disposed in the spot S12. At this time, the control unit 1012 displays information M12 indicating that the image of the product R12 is being captured in the vicinity of the spot S12.

The control unit 1012 displays a menu in the vicinity of the spot S14. The menu is a menu in which a function exerted in the spot S14 is selected. Thus, the control unit 1012 may display selection alternatives of the function exerted in the spot, and may allow the user to select a function.

### Ninth Modification Example

The control unit 1012 may determine the aspect of the spot according to the user.

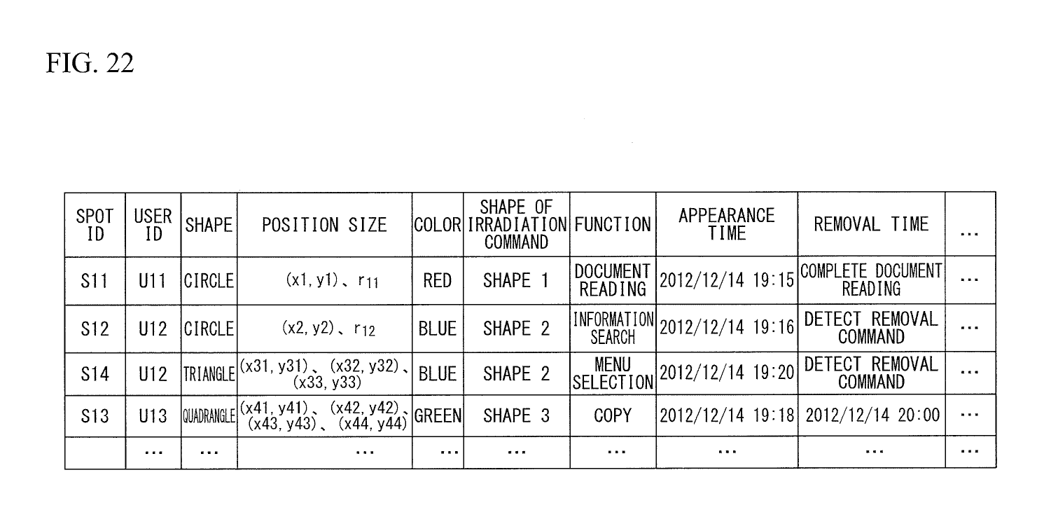

FIG. 22 is a schematic view illustrating an example of an input range table according to the ninth modification example of this embodiment. The input range table includes a row of each item such as a spot ID, a user ID, a shape, a position size, a color, a shape of an indication, a function, an appearance time, and a removal time. In the input range table, the input range information is stored for each spot ID. Furthermore, the input range table is stored in the input range information storage unit 124.

For example, according to the input range information of a first line in FIG. 22, the user of the spot “S11” is the user “U11”, and the spot “S11” is in the shape of “Circle” having the radius r₁₁ in the center coordinates of “(x1,y1)”. In addition, the color of the spot S11 is “Red”, and the shape of the irradiation indication which is a trigger of the appearance is “Shape 1” (for example, an L-shape). The spot S11 allows “Document Reading” which reads the described contents by the textual analysis to be exerted. The spot S11 appears at “19:15 on Dec. 14, 2012”, and is removed when the document reading is completed. Furthermore, the control unit 1012 may store the number of times in advance in which the function is exerted until the spot is removed. In this case, when the function is exerted the stored number of times, the control unit 1012 removes the spot.

The input range table in FIG. 22 indicates that a color is able to be selected for each user. For example, the color of the spot of the user U11 is “Red”, and the color of the spot of the user U12 is “Blue”. In addition, the input range table indicating the shape of the irradiation indication is able to be selected for each user. For example, the shape of the irradiation indication of the user U11 is “Shape 1”, and the shape of the irradiation indication of the user U12 is “Shape 2”. Furthermore, the shape of the spot may be selected, and for example, the shape of the spot may be selected for each user.

The control unit 1012 may determine the aspect of the spot according to the function to be exerted. For example, the aspect of the spot may be designed according to the type of the readable information. Accordingly, the user is able to recognize the function to be exerted in the spot while observing the aspect of the spot.

In addition, the control unit 1012 may determine the aspect of the spot according to an irradiation start time, an irradiation end time, and/or a current time. For example, as with the input range information on a fourth line, for example, the removal time may be set (for example, appointed) when the spot appears. When the removal time has elapsed, the control unit 1012 removes the spot in which the removal time is set.

### Tenth Modification Example

The control unit 1012 may be integrally configured by using the optical system of the image-capturing unit 1010 and the optical system of the irradiation unit 1014 in common (an integrally configured device is referred to as an image-capturing irradiation device C1). For example, the control unit 1012 may set an optical axis of the image-capturing unit 1010 to be identical to an optical axis of the irradiation unit 1014.

The image-capturing irradiation device C1 according to the tenth modification example of this embodiment is able to have the same configuration as that of FIG. 7. In FIG. 7, the image-capturing irradiation device C1 includes the irradiation light generation unit C12, the incident and emitting light separation unit C131, the optical unit C132, and the solid image-capturing unit C141. The configuration is able to adopt the same configuration as that described with reference to FIG. 7, and is able to have the same advantages. Here, the description thereof will be omitted.

Furthermore, in the embodiments described above (including the modification examples), the shape of the object (the form (the figure, the aspect, the shape, the contour, the outline, the geometric characteristics, the geometric parameters, and/or the graphical model)) includes the shape of an object (an indication object) used in the indication. The control unit 1012 may set the shape of part of the body of the user including a wrist and an arm as the shape of the indication object, and may determine the information input range according to the shape. The control unit 1012 may determine the information input range according to the shape of the indication object such as a pointer and/or a pen. The control unit 1012 may set a picture drawn on the object and/or a printed image as the indication object, and may determine the information input range according to the shape. Accordingly, the user draws a specific picture, and thus a spot is able to appear, and various functions are able to be exerted in the spot.

In addition, the shape of the hand of the user includes the shape of the finger. In other words, the electronic controller 1001 detects the shape of the finger, and determines the information input range according to the shape of the detected finger.

When the light indicating the information input range is emitted, the control unit 1012 may darken the circumference of the light. For example, the illumination of other illuminating devices may be darkened, or the brightness around the information input range in a projection image of the device may be lowered. Accordingly, the circumference of the spot is darkened, and thus the user easily recognizes the spot.

The control unit 1012 may include an image indicating a boundary of the information input range in the projection image. For example, the control unit 1012 may dispose an edge in the information input range, and may set the color of the edge to a color different from the color of the information input range. In addition, the control unit 1012 may dispose a region which is not in the information input range around the information input range, and may set the color of the region to a color different from the color of the information input range. Accordingly, the user and the electronic controller 1001 are able to more accurately separate the information input range from the region which is not in the information input range.

The control unit 1012 may determine a wavelength (a frequency) and/or an intensity according to the function exerted in the spot and/or a usage. For example, when a function of measuring a cubic shape of the object in the spot is exerted, light having a short wavelength may be emitted as the light indicating the information input range. In addition, when a function of measuring the temperature of the object in the spot is exerted, light other than infrared light may be emitted as the light indicating the information input range. Accordingly, the electronic controller 1001 is able to more accurately measure infrared light from the object by the image-capturing unit 1010, and is able to accurately measure the temperature. Thus, the control unit 1012 may set a wavelength of light used in the measurement of the image-capturing unit 1010 to be different from a wavelength of light used in irradiation of the irradiation unit 1014.

When the object is disposed in the spot, the control unit 1012 may increase the intensity of the light indicating the information input range compared to a case before the object is disposed.

The control unit 1012 may detect an indication from the user on the basis of the sound of the user. For example, the control unit 1012 may determine the position, the size, the aspect, or the direction of the information input range according to the sound of the user. The control unit 1012 may allow the spot to appear according to the sound of the user, and may remove the spot. For example, when it is detected that the user produces a sound of “Spot”, the control unit 1012 may determine the information input range according to the shape of the hand of the user. In addition, the control unit 1012 may register the shape of the irradiation indication or the shape of the removal indication according to the sound of the user. The control unit 1012 may certify the user according to the sound of the user, and thus may identify the user. The control unit 1012 may adjust the position, the size, the aspect, or the direction of the information input range according to the sound of the user.

The control unit 1012 may set a use authority. The control unit 1012 may allow the spot to appear according to the indication only from a specific user, and may not allow the spot to appear in the indication of the other users. In addition, the control unit 1012 may limit a function which is able to be used in the spot, or may limit the type of the spot to appear according to the user.

The control unit 1012 may determine the aspect of the spot according to the usage and/or the use authority. For example, the control unit 1012 may respectively set a spot which is able to be used by an individual user, a spot which is able to be used by a plurality of users who participate in a group, or a spot which is able to be used by any one as a specific color.

The control unit 1012 may unite the information input range. For example, when at least part of a plurality of information input ranges is superimposed, the control unit 1012 may unite these information input ranges. Accordingly, the user is able to unite the spots, and is able to enlarge the spot. In addition, the user is able to easily generate the spot having various shapes. In addition, when the information input ranges are united, the control unit 1012 may combine a function which is exerted in the information input ranges after being united and a function which is exerted in the information input ranges before being united, or may allow the user to select the function. For example, the control unit 1012 may unite an information input range in which a copy function is exerted with an information input range in which a “Document Reading” function is exerted, and may generate an information input range in which a function of copying only a document read by the “Document Reading” function is exerted.

(C1.13: Acquisition of Information of Storage Unit)

When an electronic device which is able to perform communication is disposed in the spot, the control unit 1012 may communicate with the electronic device. When the electronic device starts to communicate with the electronic controller 1001, the electronic device may notify the electronic controller 1001 of the start of the communication by using the display and/or the sound. In contrast, when the electronic controller 1001 does not communicate with the electronic device, the control unit 1012 may display the effect. In addition, the control unit 1012 may acquire the information stored in the electronic device through communication between the electronic controller 1001 and the electronic device. That is, the control unit 1012 recognizes the electronic device in the spot, and acquires the information included in the recognized electronic device. Furthermore, the electronic controller 1001 may perform optical wireless communication with respect to the electronic device in the spot.

The control unit 1012 may store distance information indicating a distance between a surface to be irradiated and the electronic controller 1001 in advance, and may generate an irradiation image including the image of the light indicating the information input range on the basis of the distance information and the input range information. In addition, when the optical system is different in the irradiation and the capturing, the control unit 1012, for example, may store optical information including information indicating the position and the direction of the optical axis of each of the optical systems and information indicating a field angle of the optical system in advance. The control unit 1012 generates the irradiation image including the image of the light indicating the information input range on the basis of the optical information, and emits light such that the spot is coincident with the information input range.

The control unit 1012 may detect an articulation portion of the object, and may determine the information input range according to a line connecting articulations.

When the information input range is determined as a rectangle (for example, FIG. 19(A)), the control unit 1012 may store the length of one side in advance, and may determine the length of another side according to a ratio of the length of the index finger (a length from the root portion of the thumb to the fingertip of the index finger) and the length of the thumb. In addition, the control unit 1012 may determine the length of the one side of the rectangle according to the length of the index finger.

Furthermore, the optical unit C132, for example, may be a fish-eye lens. Accordingly, the electronic controller 1001 is able to emit light in a wide range and is able to capture an image in a wide range. Furthermore, when an influence of a distortion in the image due to the surface to be irradiated and the optical system is not considered, the control unit 1012 may not include the image conversion unit 120.

Furthermore, in the embodiments described above (including the modification examples), the light emitted from the irradiation unit 1014 indicates the information input range, but alternatively, the display unit such as a display may display the information input range. As an example in which such a display unit is used, a case where a part or all of the top plate surface of the desk in FIG. 8 is configured of a liquid crystal display, a case where a flexible display of an organic EL is attached to a wall surface of a room, and the like are included. In this case, the display unit displays a diagram indicating the information input range which is determined according to the shape of the object. Further, the display unit may have a function of displaying not only the light indicating the information input range but also the information acquired by the electronic controller 1001. In addition, the display unit and the image-capturing unit 1010 configuring the electronic controller 1001 may be respectively disposed in separated positions. In addition, the display unit may further include an information input unit such as a touch panel. Then, the electronic controller 1001 of the embodiments described above is able to realize all of the functions of the embodiments described above by substituting the irradiation unit 1014 with the display unit.

Furthermore, part of the electronic controllers 1 and 1001 of the embodiments described above may be realized by a computer. In this case, part of the electronic controllers 1 and 1001 of the embodiments described above may be realized by recording a program for realizing this control function in a computer readable recording medium, by reading the program recorded in the recording medium in a computer system, and by executing the program. Furthermore, here, the “computer system” is a computer system embedded in the electronic controllers 1 and 1001, and includes hardware such as an OS or a peripheral device. In addition, the “computer readable recording medium” is a portable medium such as flexible disk, magnetic optical disk, a ROM, and a CD-ROM, and a storage device such as hard disk embedded in the computer system. Further, the “computer readable recording medium” may include a recording medium dynamically storing a program for a short period of time, such as a communication line in a case where a program is transmitted through a network such as the Internet or a communication circuit such as a telephone circuit, and a recording medium storing a program for a certain period of time, such as a volatile memory in the computer system which is a server or a client in the above-described case. In addition, the program described above may be a program for realizing part of the functions described above, or may be a program which is able to realize a combination with a program in which all of the functions described above are recorded in the computer system. In addition, a part or all of the electronic controllers 1 and 1001 of the embodiments described above may be realized as an integrated circuit such as Large Scale Integration (LSI). Each functional block of the electronic controllers 1 and 1001 may be independently processed, or a part or all of the functional blocks may be integrated and processed. In addition, a method of circuit integration is not limited to the LSI, but may be realized by a dedicated communication circuit, or a general-purpose processor. In addition, when a technology of circuit integration which is a substitute for the LSI appears due to an advancement of conductor technology, an integrated circuit of the technology may be used.

As described above, one embodiment of the invention is described in detail with reference to the drawings, but the specific configuration is not limited to the above description, and is able to be variously changed within a range, without deviating from the gist of the invention.

What is claimed is:

1. An electronic controller, comprising:
an image-capturing unit;
an irradiation unit configured to emit light;
a recognition unit configured to recognize a type of an object existing in an input region indicated by the light emitted from the irradiation unit, the object being an object captured by the image-capturing unit; and
an acquisition unit configured to acquire information which is included in the object of which the type is recognized by the recognition unit and is according to the type of the object.

2. The electronic controller according to claim 1, further comprising:
a communication unit configured to perform communication,
wherein when the object existing in the input region is recognized as an object including a communication function and a storage device by the recognition unit, the acquisition unit acquires information stored in the storage device by communicating with the object existing in the input region.

3. The electronic controller according to claim 1,
wherein when the object existing in the input region is recognized as an object which displays information on a surface by the recognition unit, the acquisition unit acquires the information displayed on the surface of the object existing in the input region from an image captured by the image-capturing unit.

4. The electronic controller according to claim 1,
wherein when the object existing in the input region is recognized as an object indicating information by a shape or a hue by the recognition unit, the acquisition unit acquires information based on the shape of the object existing in the input region.

5. The electronic controller according to claim 1,
wherein the recognition unit recognizes types of a plurality of objects existing in the input region, and
the acquisition unit acquires information based on a combination of the types of the plurality of objects recognized by the recognition unit.

6. The electronic controller according to claim 1,
wherein the recognition unit recognizes types of a plurality of objects existing in the input region, and
the electronic controller further comprises a processing unit configured to perform processing based on a combination of the types of the plurality of objects recognized by the recognition unit.

7. The electronic controller according to claim 6,
wherein the recognition unit recognizes the types of the plurality of objects existing in the input region, and
the processing unit performs processing based on a recognition sequence in which the plurality of objects is recognized by the recognition unit.

8. The electronic controller according to claim 5, further comprising:
a communication unit configured to perform communication,
wherein when the object existing in the input region is recognized as an object including a communication function and a storage device, and part of a body of a particular person by the recognition unit, the processing unit acquires information where information relevant to the particular person is extracted from information which is acquired by communicating with the object and is stored in the storage device.

9. An electronic controller, comprising:
an image-capturing unit;
an irradiation unit configured to emit light;
a communication unit; and
an acquisition unit configured to acquire information stored in a storage device of an object by communicating with the object existing in an input region indicated by the light emitted from the irradiation unit, the object being captured by the image-capturing unit.

10. An electronic controller, comprising:
an image-capturing unit;
an irradiation unit configured to emit light;
a communication unit; and
an acquisition unit configured to acquire information stored in a storage device of an object when communication with respect to the object existing in an input region indicated by the light emitted from the irradiation unit is established, the object being captured by the image-capturing unit, to acquire information displayed on a surface of the object existing in the input region from an image captured by the image-capturing unit when the communication with respect to the object existing in the input region is not established, or to acquire information based on a shape or a hue of the object existing in the input region.

11. A control method of an electronic controller which includes an image-capturing unit and an irradiation unit emitting light, the method comprising:
using a control computer of the electronic controller for:
recognizing a type of an object existing in an input region indicated by the light emitted from the irradiation unit, the object being captured by the image-capturing unit; and
acquiring information according to the recognized type of the object, the information being included in the object of which the type is recognized.

12. A control program causing a control computer an electronic controller, which includes an image-capturing unit and an irradiation unit emitting light, to:
recognize a type of an object existing in an input region indicated by the light emitted from the irradiation unit, the object being captured by the image-capturing unit; and
acquire information according to the recognized type of the object, the information being included in the object of which the type is recognized.

13. An electronic controller, comprising:
an image-capturing unit;
a control unit configured to determine an information input range into which information is input according to a shape of an object captured by the image-capturing unit; and
an irradiation unit configured to emit light indicating the information input range,
wherein the information is able to be input in the information input range in a state in which the light is emitted.

14. The electronic controller according to claim 13,
wherein the control unit determines a size of the information input range according to the shape of the object.

15. The electronic controller according to claim 13,
wherein the control unit detects a line relevant to the shape of the object, and determines the size of the information input range according to the detected line.

16. The electronic controller according to claim 15,
wherein the control unit detects a plurality of straight lines relevant to the shape of the object as the line, and determines the size of the information input range according to a positional relationship of the respective straight lines.

17. The electronic controller according to claim 16,
wherein the control unit determines the size of the information input range according to an angle between at least two straight lines among the plurality of detected straight lines.

18. The electronic controller according to claim 17,
wherein the control unit determines a diagram which is tangent to the two straight lines as the information input range.

19. The electronic controller according to claim 15,
wherein the control unit detects a curved line relevant to the shape of the object as the line, and determines a diagram approximate to the curved line as the information input range.

20. The electronic controller according to claim 13,
wherein the control unit determines a position of the information input range according to the shape of the object.

21. The electronic controller according to claim 20,
wherein the control unit detects a plurality of straight lines relevant to the shape of the object, and determines the position of the information input range to be tangent to the plurality of straight lines.

22. The electronic controller according to claim 13,
wherein the control unit determines the information input range according to a shape of a finger which is the object.

23. The electronic controller according to claim 13,
wherein the control unit acquires information included in a target positioned in the information input range.

24. The electronic controller according to claim 23,
wherein the control unit acquires image information in which the image-capturing unit captures the target.

25. The electronic controller according to claim 23,
wherein when information is stored in a storage unit included in the target, the control unit acquires the information.

26. The electronic controller according to claim 13,
wherein when the irradiation unit emits the light, the control unit darkens a circumference of the light.

27. The electronic controller according to claim 13,
wherein the control unit determines an aspect of the information input range according to a user.

28. The electronic controller according to claim 27,
wherein the control unit determines a color or a shape of the information input range according to the user.

29. The electronic controller according to claim 13,
wherein the irradiation unit irradiates an image, which is able to be selected by the user, together with the information input range.

30. A control method of an electronic controller which includes an image-capturing unit and an irradiation unit emitting light, the method comprising:
using a control computer of the electronic controller for:
capturing an image of an object by an image-capturing unit;
determining an information input range into which information is input according to a shape of the image-captured object by a control unit; and
emitting light indicating the determined information input range by an irradiation unit,
wherein the information is able to be input in the information input range in a state in which the light is emitted.

31. A control program causing a control computer an electronic controller, which includes an image-capturing unit and an irradiation unit emitting light, to:
capture an object;
determine an information input range into which information is input according to a shape of the image-captured object; and
emit light indicating the determined information input range,
wherein the information is able to be input in the information input range in a state in which the light is emitted.
